(19) United States
(12) Patent Application Publication
(10) Pub. No.: US 2002/0077365 A1
(43) Pub. Date: Jun. 20, 2002

(54) Method for increasing the effectiveness of antiinfective

(75) Inventors: J. Brian Windsor, Austin, TX (US); Stan J. Roux, Austin, TX (US); Alan M. Lloyd, Austin, TX (US)

Correspondence Address: FULBRIGHT & JAWORSKI L.L.P., A REGISTERED LIMITED LIABILITY PARTNERSHIP, SUITE 2400, 600 CONGRESS AVENUE, AUSTIN, TX, 78701, US

(73) Assignee: The University of Texas System

(21) Appl. No.: 09/949,268

(22) Filed: Sep. 7, 2001

Related U.S. Application Data
(60) Provisional application No. 60/231,088, filed on Sep. 8, 2000.

(51) Int. Cl. A01N 47/34; A01N 37/00; A01N 37/18

(52) U.S. Cl. 514/621; 504/329; 514/553; 504/149

(57) ABSTRACT

The present invention relates to methods for decreasing the resistance of microbial strains to antiinfectives such an antibiotics and antifungals by altering the ATP gradient across biological membranes. The altering of the ATP gradient across biological membranes is achieved through the inhibition of ecto-phosphatase activity and/or ABC transporter molecule activity which may be useful to reduce resistance in bacteria and yeast to aid in the treatment of certain infections and disease and to lower the concentration of antiinfectives necessary to inhibit the growth of microbial strains.

This application claims the priority of U.S. Provisional Application Ser. No. 60/231,088, filed Sep. 8, 2000, the disclosure of which application is specifically incorporated herein by reference in the entirety. The present invention involves subject matter developed under NSF Grant Numbered IBN9603884 and other federal funds, so that the United States Government may have certain rights herein.

### FIELD OF THE INVENTION

The invention relates generally to the field of cellular biology. More specifically, the invention methods and compositions for modulating the drug resistance pathways of cells for modification of resistance to certain drug molecules.

### BACKGROUND OF THE INVENTION

The term “drug” encompasses chemicals with biological activity altering the physiology of a biological organism or its cells in some way. In such broad terms, “drug” can be used to include chemicals with activity on all organisms, wherein such chemicals may be referred to as drugs and more specifically classified as antiinfectives which include, but are not limited to, antibiotics and antifungals. Modulation of drug resistance entails modulation of an extra-cellular phosphatase (ecto-phosphatase) and an ABC (ATP-binding cassette) transporter in order to achieve the desired effect on drug resistance. Stimulation of the ecto-phosphatase either alone or together with stimulation of the ABC transporter yields an increased resistance to drug molecules while inhibition of the ecto-phosphatase alone or together with the ABC transporter yields reduced resistance to the drug molecule. Drug resistance is achieved through the altering of the ATP gradient across biological membranes which is effectuated through the modulation of an ecto-phosphatase either alone or together with an ABC transporter molecule. Modulation of drug resistance as described herein is useful in reducing resistance to and/or potentiating the action of antibiotics, antifungal agents, and other drugs in microorganisms for the treatment of infections and disease. The present invention is directed to antibiotic and antifungal resistance reversal agents and antibiotic/antifungal potentiating or synergizing agents whose activity is thought to be due to the modulation of apyrase or other ecto-phosphatases and/or ABC transporter activity in cells and modification of membrane transport, which specifically alters the ATP gradient across biological membranes.

Cells can use a phenomenon called symport to move soluble products across biological membranes. Symport is a form of coupled movement of two solutes in the same direction across a membrane by a single carrier. Examples of proton and sodium-linked symport systems are found in nearly all living systems. The energetics of the transport event depend on the relative size and electrical nature of the gradient of solutes.

Transport processes have been classified on the basis of their energy-coupling mechanisms. Currently there are four classifications: (1) Primary Active Transport which uses either a chemical, light or electrical energy source, (2) Group Translocation which uses chemical energy sources, (3) Secondary Active Transport which uses either a sodium or proton electrochemical gradient energy source, and (4) Facilitated Diffusion which does not require an energy source (Meyers, 1997). The present invention is related to transport molecules belonging to the first class of transport processes, primary active transport, and therefore, this type of transport will be discussed in further detail.

Primary active transport refers to a process whereby a “primary” source of energy is used to drive the active accumulation of a solute into or extrusion of a solute from a cell. Transport proteins include P-type ATPases and ABC-type ATPases. These types of transport systems are found in both eukaryotes and prokaryotes. The bacterial ABC-type transporters, which are ATP driven solute pumps, have eukaryotic counterparts. Additionally, many transmembrane solute transport proteins exhibit a common structural motif. The proteins in these families consist of units or domains that pass through the membrane six times, each time as an α-helix. This has led to the suggestion that many transport proteins share a common evolutionary origin, but this is not true of several distinct families of transport proteins. Numerous structurally distinct bacterial permeases, as well as several homologous eukaryotic transport systems, share a common organization (Meyers, 1997).

Two hydrophilic domains or proteins function to couple ATP hydrolysis in the cytoplasm to activate substrate uptake or efflux, and two hydrophobic domains or proteins function as the transmembrane substrate channels. These proteins or protein domains constitute what is referred to as the ABC (ATP-binding cassette) superfamily. Either the two hydrophilic domains or proteins or the two hydrophobic domains or proteins (or both) may exist either as heterodimers or homodimers. If, as in most bacterial systems, each of these constituents is a distinct protein, then either one or two genes will code for them, depending on whether both are homodimers, one is a homodimer and one is a heterodimer, or both are heterodimers. The best characterized of the eukaryotic proteins included in this family are the multidrug-resistance (MDR) transporter and the cystic fibrosis related chloride ion channel of mammalian cells (cystic fibrosis transmembrane conductance regulator or CFTR) (Meyers, 1997).

Multidrug resistance (MDR) is a general term that refers to the phenotype of cells or microorganisms that exhibit resistance to different, chemically dissimilar, cytotoxic compounds. MDR can develop after sequential or simultaneous exposure to various drugs. MDR can also develop before exposure to many compounds to which a cell or microorganism may be found to be resistant. MDR which develops before exposure is frequently due to a genetic event which causes the altered expression and/or mutation of an ATP-binding cassette (ABC) transporter (Wadkins et al., 1997). This is true for both eukaryotes and prokaryotes.

One prominent member of the ABC family, P-glycoprotein (Pgp; also known as multidrug resistance protein or MDR1), which is a plasma-membrane glycoprotein that confers a multidrug resistance (MDR) phenotype on cells, is of considerable interest because it provides one mechanism of possibly inhibiting resistance in tumor cells to chemotherapeutic agents (Senior et al., 1995). Pgp is a single polypeptide of ˜1280 amino acids with the typical ABC transporter structure profile. Studies have shown that overexpression of Pgp is responsible for the ATP-dependent extrusion of a variety of compounds, including chemotherapeutic drugs, from cells (Abraham et al., 1993).

Over one-hundred ABC transporters have been identified in species ranging from Escherichia coli to humans (Higgins, 1995). For example, the bacteria Lactococcus lactis expresses an ABC transporter, LmrA, which mediates antibiotic resistance by extruding amphiphilic compounds from the inner leaflet of the cytoplasmic membrane (van Veen. et al., 1998). Furthermore, over-expression of LmrA can confer MDR in human lung fibroblasts and LmrA has similar molecular and biochemical properties to Pgp. Thus, bacterial LmrA and Pgp are functionally interchangeable. Id. Additionally, the plant Arabidopsis thaliana encodes an ATP transporter, AtPGP-1, which is a putative Pgp homolog (Dudler and Hertig, 1992). Similarly, the yeast Saccharomyces cerevisiae equivalent of Pgp, STS1 (Bissinger et al., 1994), has been cloned and shown to confer multidrug resistance when over-expressed in yeast. Equivalent results have been shown in the yeast Pdr5p, which has recently been shown to be very similar or identical to STP1 (Kolacskowski et al., 1996). Taken together, these results suggest that this type of multidrug resistance efflux pump is conserved from bacteria to humans.

While various theories of ABC transporter function have become popular, there is still no precise molecular-level description for the mechanism by which over-expression lowers intracellular accumulation of drugs, in particular how Pgp lowers intracellular accumulation of chemotherapeutic drugs. However, it has been shown that Pgp over-expression also changes plasma membrane electrical potential and intracellular pH which could potentially greatly affect the cellular flux of a large number of compounds to which Pgp confers resistance (Wadkins and Roepe, 1997). Also included in the ABC transporter superfamily are the Cystic Fibrosis Transmembrane Conductance Regulator (CFTR) and the Sulfonyl Urea Receptor (SUR).

CFTR and SUR are expressed in the lung epithelium and the β cells of the pancreas, respectively, as well as in other tissues. CFTR functions as a low conductance ATP and cyclic AMP-dependent Cl⁻ channel that also appears to have additional important functions, such as modulation of epithelial Na⁺ conductance and regulation of outwardly rectified chloride channels (Wadkins and Roepe, 1997). Mutations in the CFTR gene produce altered CFTR proteins with defects in CFTR function, leading to profound alterations in epithelial salt transport and altered mucous properties in cystic fibrosis patients that result in chronic lung infections associated with the disease. Id. SUR is triggered by sulfonyl urea drugs to depolarize pancreatic, β cells that leads to Ca²⁺ influx, which stimulates fusion of insulin-containing vesicles to the plasma membrane. Id.

An ATP transporter hypothesis has been suggested for Pgp, CFTR and SUR which theorizes that these ABC transporters function as ATP transport channels (Abraham et al., 1995; Schweibert, 1995; Al-Awqati, 1995). The ATP channel hypothesis, however, has been viewed with skepticism. This is partly due to the inability to show the same results with preparations including purified and reconstituted CFTR, suggesting that the ATP conductance that was originally observed may have been mediated by another protein, not present in the purified system, that is influenced by CFTR (Wadkins and Roepe, 1997). There has been no such negative data reported with respect to the ATP channel hypothesis for Pgp or SUR, but the controversy over CFTR has raised doubt for Pgp and SUR as well.

In support of the ATP channel hypothesis, Huang et al. (1992) have suggested that extracellular ATP leads to elevations in pH, and Weiner et al. (1986) have suggested that extracellular ATP may regulate Na⁻/H⁺ exchange in Ehrlich ascites tumor cells. It has also been observed that changes in Pgp levels affects pH and plasma membrane electrical potentials which could be connected to recent observations suggesting the involvement of ATP transport in MDR.

Additionally, Abraham et al. (1993) have reported that the addition of extracellular ATP to MDR cell lines confers sensitivity to drugs abolishing MDR. The data for this effect were not presented in the article and no further explanation was given for this phenomenon. Furthermore, there have been no subsequent publications addressing or explaining this effect.

Furthermore, Ujhazy et al. (1996) have shown that ecto-5′-nucleotidase is up-regulated in certain MDR cell lines. Ecto-5′-nucleotidase is the final enzyme in the extracellular pathway for salvage of adenosine from phosphorylated purines (Zimmerman, 1992). The proposed hypothesis for the involvement of ecto-5′-nucleotidase in drug resistance considers its role in the maintenance of intracellular ATP pools through the adenosine salvage pathway (Ujhazy et al. 1996). Ecto-5′-nucleotidase specifically acts in adenosine salvage pathways, converting AMP to adenosine which is more readily taken up by the cell and utilized as a precursor for ATP production. Therefore, ecto-5′-nucleotidase may be acting in certain MDR cell lines as a mechanism by which the cell circumvents the loss of ATP (due to up-regulated transport proteins which possibly form ATP transport channels) by creating higher levels of adenosine from which the cell can produce ATP. Correspondingly, 63% of MDR cell line variants tested expressed ecto-5′-nucleotidase. These observations suggested that a salvage mechanism for extracellular nucleotides may be another way by which certain MIDR cells counterbalance their ATP losses from efflux induced by the over-expression of ABC transporters involved in MDR. Consistent with this hypothesis, inhibitors of ecto-5′-nucleotidase conferred sensitivity to certain drugs in MDR cell lines which over-express the ecto-5′-nucleotidase.

It is also interesting to note that yeast, which do not have an adenosine salvage pathway (Boyum and Guidotti, 1997), do contain a Pgp-like gene called STS1 (Bissinger and Kucher 1994). Therefore, since the adenosine salvage pathway is unlikely to be involved in yeast multidrug resistance, other mechanisms are likely to exist.

Recent reports have confirmed the existence of ATP in the extracellular matrix (ECM) of both multicellular organisms and unicellular organisms (Sedaa et al., 1990; Boyum and Guidotti 1997), respectively. However, no such reports are available which suggest the existence of ATP in the ECM of plants before the present invention. These reports have prompted further investigations of the fate of ATP outside the cell.

One of the largest gradients in biological systems is that of ATP. It is a million-fold more concentrated inside the cell than outside. Apyrases are enzymes whose unifying characteristic is their ability to hydrolyze the gamma phosphate of ATP and to a lesser extent, the beta phosphate of ADP (Plesner, 1995). Most apyrases are expressed as plasma membrane associated proteins with their hydrolytic activity facing into the ECM (Wang and Guidotti 1996). Extracellular apyrases are generally referred to as ecto-apyrases. Given reports that show the existence of extracellular ATP, one observation regarding ecto-apyrase is that it hydrolyzes the extracellular ATP. In fact, work in animal systems has shown that apyrases hydrolyze ATP in the ECM as part of the adenosine salvage pathway con-jointly with ecto-5′-ectonucleotidase (Che, 1992). The existence of a similar ecto-apyrase system has not been reported in plants prior to the present invention. Additionally, ecto-apyrases have not been shown, prior to the present invention, to have a role in MDR.

While some references appear to indicate that MDR may act at the level of ATP transport, the role of ATP in MDR has not been adequately elucidated and has remained a point of contention in the field. The present invention provides insight into the role of ATP transport in MDR by showing that the extracellular ATP pool in cells is critical in MDR. Although the adenosine salvage pathway may help compensate for ATP losses in MDR by providing a mechanism to recoup adenosine, it is not the critical aspect of the role of ATP in MDR as evidenced by the observation that only a subset of MDR cell lines resort to this mechanism via the up-regulation of ecto-5′-nucleotidase to maintain drug resistance. In fact, the previous data teach away from modulating extracelluar ATP levels and place the focus on mechanisms which are involved in modulating intracellular ATP levels. Since AMP is the preferred substrate for ecto-5′-nucleotidase, with ATP and ADP being poor substrates (Zimmerman, 1992), it is unlikely that ecto-5′-nucleotidase is involved in modulating extracellular levels of ATP. While high levels of ATP have been demonstrated to be useful in the inhibition of tumor growth, its effects on tumor cells have been shown to prevent cell growth and induce cell death through the inhibition of the S phase of the cell cycle (U.S. Pat. No. 4,880,918). There has been no implication, prior to the present invention, of the importance of modulating extracellular ATP levels in MDR.

The present invention deals with the compounds described herein, which act as an inhibitor to the ecto-phosphatase. Such inhibitors and methods for identifying such inhibitors would be useful for studying the importance of ecto-phosphatases in MDR, for modulating MDR and in industrial applications (e.g. determining the titer of microbia in soil).

It would be particularly useful to have more effective mechanisms by which to modulate drug resistance in various organisms. In particular, since the use of Pgp inhibitors has not been totally efficient in overcoming the resistance seen in tumor cells which have been repeatedly exposed to chemotherapeutic agents, it would be useful to have other mechanisms by which to combat such resistance in tumor cells to provide more effective chemotherapeutic treatments. There are many applications for the modulation of drug resistance which are contemplated by the present invention, such as the identification of compounds with activity as adjuvants to antibiotics, antifungals and pesticides, as well as many other chemicals, where an adjuvant compound is one that increases the effectiveness of another agent/chemical or decreases the amount of another agent/chemical necessary to produce a desired biological effect.

### SUMMARY OF THE INVENTION

In one aspect, the present invention is directed to a method for the modulation of drug resistance in cells. In one embodiment of the invention, the compositions and methods of the present invention are adjuvants that result in an increase in the effectiveness of another chemical, such as an antiinfective, or a decrease in the amount of another chemical, such as an antiinfective, that is necessary to produce the desired biological effect. Antiinfectives, as described herein, shall include but not be limited to antibiotics and antifungals. The adjuvant activity of the present invention may be conferred through manipulation of membrane transport in humans, animals, plants, bacteria, fungi and all other organisms.

In another aspect, the invention provides a method for increasing the sensitivity of a target cell to an antiinfective comprising contacting the target cell with suramin. The suramin may have the molecular formula of Formula XIX. In certain embodiments of the invention, the target cell may be a bacterial, yeast, plant or animal cell. The antiinfective may, in particular embodiments of the invention, be an antifungal or antibiotic. The suramin may be contemporaneously administered with the antiinfective. By “contemporaneously,” it is meant that the antiinfective is administered sufficiently close in time with the administration of the suramin to observe an increase in the sensitivity of the target cell to the antiinfective. Alternatively, the antiinfective and suramin may be simultaneously administered. In one embodiment of the invention, the suramin is administered to the target cell with a pharmaceutical composition. As used herein, a “pharmaceutical composition” is a composition specifically formulated for the delivery of one or more drugs to a target organism, part thereof or cell. In one embodiment of the invention, the pharmaceutical composition may be administered to an organism comprising the target cell. In such instances, the target cell may have infected the organism, or may represent a cell of the host organism itself. The pharmaceutical composition may comprise the antiinfective. The method may comprise contemporaneously administering the antiinfective and the suramin to an organism comprising the target cell. In certain embodiments of the invention, the organism may be a plant or animal cell, including a mammal, and may further be a human.

In yet another aspect, the methods of the invention may be further defined as a method for decreasing drug resistance of a target cell, wherein the target cell exhibits multidrug resistance, comprising contacting the target cell with suramin. The target cell may be resistant to any antiinfective, including an antibiotic or antifungal. Contacting may comprise administering the suramin in a pharmaceutical composition.

In still yet another aspect, the invention provides a method for increasing the sensitivity of a plant cell to a herbicide comprising contacting the plant cell with suramin. In one embodiment of the invention, the method comprises contacting the plant cell with a molecule having Formula XX. The method may also be further defined as comprising contemporaneously administering said herbicide and said suramin, including simultaneously administering said herbicide and said suramin. The method may also comprise contacting a plant comprising the plant cell with the suramin. The plant may be further defined as resistant to at least a first herbicide.

In still yet another aspect, the invention provides a pharmaceutical composition comprising suramin and an antibiotic and /or an antifungal in a pharmaceutically acceptable carrier or diluent. In another embodiment of the invention, a composition comprising suramin and a pesticide is provided. In certain embodiments of the invention, the pesticide may be further defined as a fungicide, insecticide, herbicide, nematicide, miticide or algeacide.

### DESCRIPTION OF THE DRAWINGS

FIG. 1. Expression of apyrase in pea and in transgenic plants (A) Immunoblot analysis of subcellular fractions from etiolated pea plants. (B) Top, the total phosphate accumulated in the shoots of three independent transgenic plants. Bottom, a corresponding immunoblot performed on protein from ECM of wild-type and transgenic plants. (C) Assay of phosphatase activity in the ECM fraction of OE1 and wild-type.

FIG. 2. Transport of the products of ATP hydrolysis by transgenic plants overexpressing apyrase and by wild-type plants.

FIG. 3. Conference of resistance to cycloheximide (A and B) and nigericin (C and D) in wild-type and ecto-phosphatase deficient yeast over-expressing the Arabidopsis plant ABC transporter, AtPGP-1.

FIG. 4. Conference of resistance to cycloheximide (A) and cytokinin (B) in Arabidopsis plants over-expressing either the ecto-phosphatase, apyrase, or the ABC transporter, AtPGP-1.

FIG. 5. Graph showing the growth turbidity of YMR4 yeast over-expressing the Arabidopsis plant ABC transporter AtPGP-I grown in cycloheximide (A) or nigericin (B and C).

FIG. 6. Graph showing germination rate of Arabidopsis plants grown in the presence of cycloheximide which over-express either the ecto-phosphatase, apyrase, or the ABC transporter AtPGP-1.

FIG. 7. Graph of steady-state levels of ATP in the extracellular fluid of wild-type yeast cells grown in the presence or absence of glucose and in the presence or absence of overexpression of the Arabidopsis plant ABC transporter, AtPGP-1.

FIG. 8. Graph showing that over-expression of Arabidopsis plant ABC transporter, tPGP-1, in yeast can double the steady-state levels of ATP in the extracellular fluid.

FIG. 9. Graph showing that a yeast mutant, YMR4, that has a deficient ecto-phosphatase, accumulates ATP in the extracellular fluid and the over-expression of AtPGP-1 increases the accumulation of ATP.

FIG. 10. Graph showing results of a pulse-chase experiment in either wild-type yeast cells or a yeast mutant, YMR4, which is deficient in ecto-phosphatase activity, in the presence and absence of over-expression of Arabidopsis plant ABC transporter, AtPGP-1, demonstrating an early differential ATP efflux of cells over-expressing AtPGP-1.

FIG. 11. Graph of ATP levels on the surface of leaves of Arabidopsis plants over-expressing AtPGP-1 (MDR1).

FIG. 12. Effects of phosphatase inhibitor in wild-type and AtPGP-1 (MDR1) overexpressing Arabidopsis plants.

FIG. 13. Growth of cycloheximide and extracellular ATP on wild-type and MDR1 overexpressing S. cerevisiae yeast cells which have either never seen cycloheximide or which have been previously selected in cycloheximide.

FIG. 14. Growth effects of cycloheximide, adenosine and phosphate on wild-type and AtPGP-1 overexpressing S. cerevisiae yeast cells.

FIG. 15. Effects of phosphatase inhibitor on the effectiveness of the fungicide chlorothalonil in the wild-type yeast strain INVSC with plasmid pvt101U.

### DETAILED DESCRIPTION OF THE INVENTION

The present invention is directed to the use of multicyclic compounds such as suramin as a potentiator or synergizer that results in an increase in the effectiveness of another chemical, such as a pharmaceutical (e.g., an antibiotic or antifungal), or a decrease in the amount of another chemical, such as a pharmaceutical (e.g., antibiotic or antifungal), that is necessary to produce the desired biological effect,

The adjuvant activity of the present invention is thought to be conferred through manipulation of membrane transport, specifically the ATP gradient across biological membranes in humans and animals, and the manipulation of the activity of ABC transporters and/or ecto-phosphatases.

### Inhibition of Drug Resistance in Microorganisms to Treat Infection

The present invention relates to methods for inhibiting or ameliorating infection in animals and humans caused by microorganisms, particularly bacterial and fungal infections using inhibitory mechanisms against an ecto-phosphatase and/or an ABC transporter to modify the ATP gradient across biological membranes. The invention is useful in the inhibition or amelioration of a wide range of infections including, but not limited to, gram-negative bacterial infections including gram-negative sepsis, gram-negative endotoxin-related hypotension and shock, rabies, cholera, tetanus, lymes disease, tuberculosis, Candida albicans, Chlamydia, and the like.

The invention is based, in part, on the unexpected result that when mutant yeast deficient in two potent extracellular ATP phosphatases were cultured in cycloheximide, they were not able to grow. Surprisingly, they were rescued by the over-expression of a plant MDA-ABC transporter AtPGP-1, suggesting that the inability to grow in the drug was caused by an inability to efflux the drug which was coupled to a deficiency in extracellular ATP phosphatase activity. Drug sensitivity in microorganisms may be increased by subjecting bacteria, fungi and yeast (as described above) to multicyclic compounds, such as suramin, that are capable of inhibiting the activity of an endogenous ecto-phosphatase and/or an ABC transporter. Such inhibitors of ecto-phosphatase and/or an ABC transporter can be used to potentiate the effectiveness of antiinfectives, such as antibiotics and antifungals. Thus the amelioration of certain infections may involve the administration of an anti-microbial agent (such as an antibiotic or an antifungal agent) with the concurrent administration of the aforementioned ecto-phosphatase and/or ABC transporter inhibitor.

Additionally, the present invention is useful in the development of genetic and epigenetic systems in humans for resistance to toxins from biological and non-biological sources. Such sources include, but are not restricted to, pathogens produced by microbial infections, pathogens and toxins derived from biological sources through human contrivance, environmental toxins not produced through biological action, and toxic substances created synthetically. In a particular embodiment, humans at risk for exposure would be vaccinated either with a gene therapy designed to bolster endogenous ATP gradients in human cells, or a chemical substance capable of enhancing the strength of the ATP gradient. In both instances, the target of the genetic or chemical therapy would be either the ABC transporter activity, ecto-phosphatase activity or both. In another embodiment of the invention, only the ABC transporter activity or the ecto-phosphatase activity in an infecting organism is diminished to inhibit drug efflux. Recombinant techniques may be used to introduce DNA sequences to the microorganism which encode for a small inhibitory molecule to either an ABC transporter or an ecto-phosphatase or both to cause the inhibition of drug efflux from the microorganism.

### Ecto-phosphatase Inhibition

Since ecto-phosphatases have been shown by the present invention to be important actors in the modulation of the ATP gradient across biological membranes and thus useful in a variety of applications (e.g. the modulation of drug resistance), it is an object of the present invention to provide methods and assays for the identification of inhibitors of ecto-phosphatases (e.g. apyrase).

A high-throughput screen was developed to rapidly identify potential inhibitors for ecto-phosphatases and is described below in Example 6. This high-throughput screen is particularly useful, as no known specific inhibitors of the apyrase enzyme exist. Using the high throughput screen, ecto-phosphatase inhibitors are isolated by screening a small molecule library (e.g. a combinatorial library) for inhibitory activity to ecto-phosphatase (e.g. apyrase activity). Once ecto-phosphatase inhibitory molecules are isolated from such a screen, the inhibitors may be further tested for their ability to specifically inhibit the ATPase activity of the ecto-phosphatase.

The ecto-phosphatase inhibitory molecules of the present invention are chemically stable and physiologically active and include, inter alia, those molecules represented by Formulae I through XX below

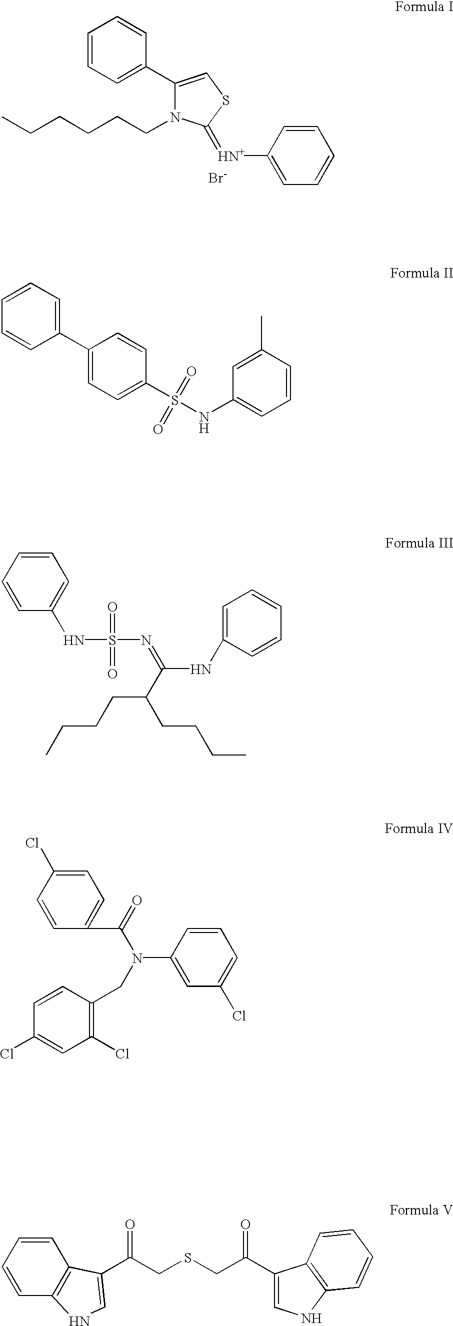

Preliminary pharmacophore studies revealed that the small molecules represented by Formulae I through XX fall into five classes of compounds (sulfanamides, guanidines, aminothiazoles, thioketones and benzamides). Most of these chemical classes are found in other physiologically-active compounds, including those having pharmaceutical and therapeutic use. For example, sulfanimides are widely used as antibiotics. Additionally, studies for the isolation of small molecules capable of reversing MDR have described molecules belonging to two of the classes of molecules of the present invention (Medina et al. 1998; Dhamant et al., 1992). The molecules described by Medina et al. have been shown to affect MDR and the mode of action of the molecules is believed to involve tubulin interactions. The thiazine derivatives described by Dhamant et al. reverse the resistance in tumor cells to vincristine.

The ecto-phosphatase inhibitory molecules of the present invention are useful in reversing MDR in Arabidopsis plants and yeast. MDR reversal in plants and yeast cells may be shown by growing the cells in the presence of relevant drugs and in the presence and absence of the inhibitor. Cells which cannot grow in the presence of a drug in the presence of an ecto-phosphatase inhibitor, have a reversal in MDR. Additionally, the ecto-phosphatase inhibitory molecules of the present invention are useful in reversing drug resistance in mammalian cell lines (e.g., normal COS-7 cells and breast cancer tumor cells (e.g., HS5787, MB231 and MB435)) grown in the presence of a drug (e.g. a chemotherapeutic agent). MDR reversal in mammalian cells may be shown by using the flourescent compound calcein-AM. Esterases present in cells cleave the aceto-methoxy ester (AM) from the calcein-AM and liberate calcein. Calcein is a flourescent compound which is excitable by the 488 nm laser of a FACS Caliber flow cytometer (Becton Dickenson, Franklin Lakes, N.J.), while the uncleaved calcein-AM is not excitable. Wild type cells incubated in the presence of calcein-AM show a high level of fluorescence while MDR state cells, which efflux the calcein-AM faster than the cellular esterases can cleave it, do not show a high level of fluorescence. The mammalian cells can be tested for the reversal of MDR with the ecto-phosphatase inhibitors of the present invention by the amount of calcein fluorescence detected in the cells. Furthermore, the relative importance of the mammalian MDR gene and the mammalian apyrase gene in MDR can also be determined.

Specificity of the ecto-phosphatase inhibitors of the present invention may be tested with the screening assay described in Example 6 below. Inhibitors are tested for their ability to inhibit acid phosphatases, alkaline phosphatases, myosin phosphatases and the luciferase ATPase. The assays may be performed using techniques known in the art.

In one preferred embodiment, the ecto-phosphatase is an apyrase and the ecto-phosphatase inhibitor is a molecule selected from among molecules represented by the Formulae I through XX. In another preferred embodiment, the ecto-phosphatase is apyrase and the ecto-phosphatase inhibitor is a molecule selected from among molecules represented by the Formulae I through V.

In a preferred embodiment, the ecto-phosphatase is apyrase and the ecto-phosphatase inhibitor is a molecule represented by Formula XX. Formula XX is suramin or 8,8′[Carbonylbis[imino-3,1-phenylenecarbonylimino(4-methyl-3,1-phenylene)carbonylimino]]bis-1,3,5-naphthalenetrisulfonic acid. Suramin has been reported as a potent non-competitive inhibitor of ecto-apyrase activity associated with the plasma membrane of cholinergic nerve terminal of Torpedo marmorata electric organs (Marti et al., 1996).

The ecto-phosphatase inhibitors of the present invention, which are acidic or basic in nature, can form a wide variety of salts with various inorganic and organic bases or acids, respectively. These salts may be physiologically acceptable for in vivo administration in humans and animals, including humans. Salts of the acidic compounds of this invention are readily prepared by treating the acidic compound with an appropriate molar quantity of the chosen inorganic or organic base in an aqueous or suitable organic solvent and then evaporating the solvent to obtain the salt. Salts of the basic compounds of this invention can be obtained similarly by treatment with the desired inorganic or organic acid and subsequent solvent evaporation and isolation. The skilled artisan can produce salts of the small molecules of the present invention using techniques known in the art.

The skilled artisan readily can determine the amount of the ecto-phosphatase inhibitor that is required to inhibit the ecto-phosphatase by measuring ATPase activity in the presence and absence of varying amounts of the inhibitor. Phosphatase activity can be determined by assessing the dephosphorylation of ATP and liberation of phosphate as described below in Example 6. Additionally, parameters may be measured that are known to be associated with ecto-phosphatase activity to determine whether the molecule has ecto-phosphatase inhibitory activity. For example, ecto-phosphatase inhibitory activity may be measured in cells (e.g. yeast, mammalian, and tumor cell lines) by assessing the loss of resistance to drugs. Furthermore, the ecto-phosphatase inhibitory molecules of the present invention may be tested for specific inhibitory activity to ecto-phosphatases versus general phosphatases or for specific inhibitory activity for a particular ecto-phosphatase activity (e.g. apyrase).

Additionally, as stated above, the ecto-phosphatase inhibitory molecules of the present invention are useful in reversing MIR. Such a reversal has several applications including reducing resistance to antimicrobial agents in microorganisms.

The present invention also provides physiologically acceptable compositions comprising an ecto-phosphatase inhibitor of the present invention and a physiologically acceptable carrier or diluent. The use of such physiologically acceptable carriers or diluents are well known in the art. The techniques of preparation of pharmaceutical compositions are generally well known in the art as exemplified by Remington's Pharmaceutical Sciences, 16th Ed. Mack Publishing Company, 1980, which reference is specifically incorporated herein by reference in its entirety. Formulation of the compounds of the present invention may be stable under the conditions of manufacture and storage and must be preserved against contamination by microorganisms.

The physiological forms of the compounds of the invention suitable for administration include sterile aqueous solutions or dispersions and sterile powders for the extemporaneous preparation of sterile injectable solutions or dispersions. Typical carriers include a solvent or dispersion medium containing, for example, water buffered aqueous solutions (i.e., biocompatible buffers), ethanol, polyols such as glycerol, propylene glycol, polyethylene glycol, suitable mixtures thereof, surfactants, and vegetable oils. Isotonic agents such as sugars or sodium chloride may be incorporated into the subject compositions.

In a particularly preferred embodiment, the compounds shown to have activity as ecto-phosphatase inhibitors may be used as adjuvants to lower the effective dose of other chemicals, including drugs such as antiinfectives, hormones, tissue factors, regulatory molecules (such as calmodulin) and other compounds.

Pharmaceutical compositions in accordance with the invention may be used by themselves or in combination with other forms active ingredients or therapeutics. One embodiment of the invention provides formulations for parenteral administration, e.g., formulated for injection via the intravenous, intramuscular, sub-cutaneous or other such routes. Typically, such compositions can be prepared as injectables, either as liquid solutions or suspensions; solid forms suitable for using to prepare solutions or suspensions upon the addition of a liquid prior to injection also can be prepared; and the preparations also can be emulsified.

Solutions of the active compounds as free base or pharmacologically acceptable salts can be prepared in water suitably mixed with a surfactant, such as hydroxypropylcellulose. Dispersions also can be prepared in glycerol, liquid polyethylene glycols, and mixtures thereof and in oils. Under ordinary conditions of storage and use, these preparations contain a preservative to prevent the growth of microorganisms.

The pharmaceutical forms suitable for injectable use include sterile aqueous solutions or dispersions; formulations including sesame oil, peanut oil or aqueous propylene glycol; and sterile powders for the extemporaneous preparation of sterile injectable solutions or dispersions. In all cases, the form must be sterile and must be fluid to the extent that easy syringability exists. It must be stable under the conditions of manufacture and storage and must be preserved against the contaminating action of microorganisms, such as bacteria and fungi.

Carriers used also can be a solvent or dispersion medium containing, for example, water, ethanol, polyol (for example, glycerol, propylene glycol, and liquid polyethylene glycol, and the like), suitable mixtures thereof, and vegetable oils. The proper fluidity can be maintained, for example, by the use of a coating, such as lecithin, by the maintenance of the required particle size in the case of dispersion and by the use of surfactants. The prevention of the action of microorganisms can be brought about by various antibacterial and antifungal agents, for example, parabens, chlorobutanol, phenol, sorbic acid, thimerosal, and the like. In many cases, it will be preferable to include isotonic agents, for example, sugars or sodium chloride. Prolonged absorption of the injectable compositions can be brought about by the use in the compositions of agents delaying absorption, for example, aluminum monostearate and gelatin.

Sterile injectable solutions are prepared by incorporating the active compounds in the required amount in the appropriate solvent with various of the other ingredients enumerated above, as required, followed by filtered sterilization. Generally, dispersions are prepared by incorporating the various sterilized active ingredients into a sterile vehicle which contains the basic dispersion medium and the required other ingredients from those enumerated above. In the case of sterile powders for the preparation of sterile injectable solutions, the preferred methods of preparation are vacuum-drying and freeze-drying techniques which yield a powder of the active ingredient plus any additional desired ingredient from a previously sterile-filtered solution thereof.

Other modes of administration can also find use with the invention. For instance, pharmaceutical compounds may be formulated in suppositories and, in some cases, aerosol and intranasal compositions. For suppositories, the vehicle composition will include traditional binders and carriers such as polyalkylene glycols or triglycerides. Such suppositories may be formed from mixtures containing the active ingredient in the range of about 0.5% to about 10% (w/w), preferably about 1% to about 2%.

Oral compositions may be prepared in the form of solutions, suspensions, tablets, pills, capsules, sustained release formulations, or powders. These compositions can be administered, for example, by swallowing or inhaling. Where a pharmaceutical composition is to be inhaled, the composition will preferably comprise an aerosol. Exemplary procedures for the preparation of aqueous aerosols may be found in U.S. Pat. No. 5,049,388, the disclosure of which is specifically incorporated herein by reference in its entirety. Preparation of dry aerosol preparations are described in, for example, U.S. Pat. No. 5,607,915, the disclosure of which is specifically incorporated herein by reference in its entirety.

Also useful is the administration of the compounds described herein directly in transdermal formulations with permeation enhancers such as DMSO. These compositions can similarly include any other suitable carriers, excipients or diluents. Other topical formulations can be administered to treat certain disease indications. For example, intranasal formulations may be prepared which include vehicles that neither cause irritation to the nasal mucosa nor significantly disturb ciliary function. Diluents such as water, aqueous saline or other known substances can be employed with the subject invention. The nasal formulations also may contain preservatives such as, but not limited to, chlorobutanol and benzalkonium chloride. A surfactant may be present to enhance absorption of the subject compounds by the nasal mucosa.

Upon formulation, solutions are administered in a manner compatible with the dosage formulation and in such amount as is therapeutically effective. The formulation of choice can be accomplished using a variety of excipients including, for example, pharmaceutical grades of mannitol, lactose, starch, magnesium stearate, sodium saccharin cellulose, magnesium carbonate, and the like. Typically, pharmaceutical compositions will contain from less than 1% to about 95% of the active ingredient, preferably about 10% to about 50%. Preferably, between about 10 mg/kg patient body weight per day and about 25 mg/kg patient body weight per day will be administered to a patient, including a human patient. The frequency of administration will be determined by the care given based on patient responsiveness. Other effective dosages can be readily determined by one of ordinary skill in the art through routine trials establishing dose response curves.

Regardless of the mode of administration, suitable pharmaceutical compositions in accordance with the invention will generally include an amount of active ingredient admixed with an acceptable pharmaceutical diluent or excipient, such as a sterile aqueous solution, to give a range of final concentrations, depending on the intended use. The techniques of preparation are generally well known in the art as exemplified by Remington's Pharmaceutical Sciences, 16th Ed. Mack Publishing Company, 1980, which reference is specifically incorporated herein by reference in its entirety. It should be appreciated that endotoxin contamination should be kept minimally at a safe level, for example, less that 0.5 ng/mg protein. Moreover, for human administration, preparations should meet sterility, pyrogenicity, general safety and purity standards as required by FDA Office of Biological Standards.

The therapeutically effective doses are readily determinable using an animal model. For example, experimental animals exhibiting a target infection or other ailment are frequently used to optimize appropriate therapeutic doses prior to translating to a clinical environment. Such models are known to be very reliable in predicting effective therapies. In certain embodiments, it may be desirable to provide a continuous supply of therapeutic compositions to the patient. For intravenous or intraarterial routes, this is accomplished by drip system. For topical applications, repeated application would be employed. For various approaches, delayed release formulations could be used that provided limited but constant amounts of the therapeutic agent over and extended period of time. For internal application, continuous perfusion of the region of interest may be preferred. This could be accomplished by catheterization, post-operatively in some cases, followed by continuous administration of the therapeutic agent. The time period for perfusion would be selected by the clinician for the particular patient and situation, but times could range from about 1-2 hours, to 2-6 hours, to about 6-10 hours, to about 10-24 hours, to about 1-2 days, to about 1-2 weeks or longer. Generally, the dose of the therapeutic composition via continuous perfusion will be equivalent to that given by single or multiple injections, adjusted for the period of time over which the injections are administered. It is believed that higher doses may be achieved via perfusion, however.

Therapeutic kits comprising the compositions described herein are also provided by the invention. Such kits will generally contain, in suitable container means, a pharmaceutically or agriculturally acceptable formulation of the active ingredient. The kits also may contain other pharmaceutically acceptable formulations, such as an antiinfective agent, including an insecticide, antifungal or antibacterial, as well as a herbicide.

The kits may have a single container means that contains the active ingredient, with or without any additional components, or they may have distinct container means for each desired agent. When the components of the kit are provided in one or more liquid solutions, the liquid solution is an aqueous solution, with a sterile aqueous solution being particularly preferred. However, the components of the kit may be provided as dried powder(s). When reagents or components are provided as a dry powder, the powder can be reconstituted by the addition of a suitable solvent. It is envisioned that the solvent also may be provided in another container means. The container means of the kit will generally include at least one vial, test tube, flask, bottle, syringe or other container means, into which the active compound, and any other desired agent, may be placed and, preferably, suitably aliquoted. Where additional components are included, the kit will also generally contain a second vial or other container into which these are placed, enabling the administration of separated designed doses. The kits also may comprise a second/third container means for containing a sterile, pharmaceutically acceptable buffer or other diluent.

The kits also may contain a means by which to administer the compositions to an animal or patient, e.g., one or more needles or syringes, or even an eye dropper, pipette, or other such like apparatus, from which the formulation may be injected into the animal or applied to a afflicted area of the body. The kits of the present invention will also typically include a means for containing the vials, or such like, and other component, in close confinement for commercial sale, such as, e.g., injection or blow-molded plastic containers into which the desired vials and other apparatus are placed and retained.

The invention also provides compositions formulated for administration to plants or parts thereof. Specific formulations for plant application are known to those of skill in the art and hare described, for example, in U.S. Pat. No. 6,242,382, the disclosure of which is specifically incorporated herein by reference in its entirety.

Examples of ingredients that may be included in a composition of the invention formulated for application to plants include surfactants, solid or liquid carriers carriers, solvents and binders. Examples of suitable surfactants that may be used for application to plants include the alkali metal, alkaline earth metal or ammonium salts of aromatic sulfonic acids, e.g., ligno-, phenol-, naphthalene- and dibutylnaphthalenesulfonic acid, and of fatty acids of arylsulfonates, of alkyl ethers, of lauryl ethers, of fatty alcohol sulfates and of fatty alcohol glycol ether sulfates, condensates of sulfonated naphthalene and its derivatives with formaldehyde, condensates of naphthalene or of the naphthalenesulfonic acids with phenol and formaldehyde, condensates of phenol or phenolsulfonic acid with formaldehyde, condensates of phenol with formaldehyde and sodium sulfite, polyoxyethylene octylphenyl ether, ethoxylated isooctyl-, octyl-or nonylphenol, tributylphenyl polyglycol ether, alkylaryl polyether alcohols, isotridecyl alcohol, ethoxylated castor oil, ethoxylated triarylphenols, salts of phosphated triarylphenolethoxylates, lauryl alcohol polyglycol ether acetate, sorbitol esters, lignin-sulfite waste liquors or methylcellulose, or mixtures of these. Common practice in the case of surfactant use is to include about 0.5 to 25% by weight, based on the total weight of the solid mixture.

Compositions for application to plants may solid or liquid. Where solid compositions are used, it may be desired to include one or more carrier materials with the active compound. Examples of carriers include mineral earths such as silicas, silica gels, silicates, talc, kaolin, attaclay, limestone, chalk, loess, clay, dolomite, diatomaceous earth, calcium sulfate, magnesium sulfate, magnesium oxide, ground synthetic materials, fertilizers such as ammonium sulfate, ammonium phosphate, ammonium nitrate, thiourea and urea, products of vegetable origin such as cereal meals, tree bark meal, wood meal and nutshell meal, cellulose powders, attapulgites, montmorillonites, mica, vermiculites, synthetic silicas and synthetic calcium silicates, or mixtures of these.

For liquid solutions, water-soluble compounds or salts may be included, such as sodium sulfate, potassium sulfate, sodium chloride, potassium chloride, sodium acetate, ammonium hydrogen sulfate, ammonium chloride, ammonium acetate, ammonium formate, ammonium oxalate, ammonium carbonate, ammonium hydrogen carbonate, ammonium thiosulfate, ammonium hydrogen diphosphate, ammonium dihydrogen monophosphate, ammonium sodium hydrogen phosphate, ammonium thiocyanate, ammonium sulfamate or ammonium carbamate.

Other exemplary components in compositions of the invention include binders such as polyvinylpyrrolidone, polyvinyl alcohol, partially hydrolyzed polyvinyl acetate, carboxymethylcellulose, starch, vinylpyrrolidone/vinyl acetate copolymers and polyvinyl acetate, or mixtures of these; lubricants such as magnesium stearate, sodium stearate, talc or polyethylene glycol, or mixtures of these; antifoams such as silicone emulsions, long-chain alcohols, phosphoric esters, acetylene diols, fatty acids or organofluorine compounds, and complexing agents such as: salts of ethylenediaminetetraacetic acid (EDTA), salts of trinitrilotriacetic acid or salts of polyphosphoric acids, or mixtures of these.

In another embodiment, the compounds and compositions of the present invention can be used to inhibit the activity of ABC transporters and/or ecto-phosphatases in pathogenic organisms. Many organisms use ABC transporters in the mechanism of their pathogenesis. For example, certain fungal plant pathogens have been shown to require activity of an ABC transporter during host infection (Urtban et al. 1999). Therefore, inhibitors of the present invention would be used to bind to and/or inhibit an ecto-phosphatase and/or an ABC transporter so that pathogenesis is inhibited. In addition to chemical compounds, the inhibition of the ecto-phosphatase and/or ABC transporter would be accomplished by expression in the target or host cell of endogenous compounds that also inhibit ecto-phosphatase and/or ABC transporter. For example, an endogenous inhibitor may be expressed in the host cell that is targeted to a pathogen of that cell. Expression of the endogenous compounds would be accomplished by one of skill in the art using methods for gene expression regulation such as antisense technology. Other methods for manipulating gene expression in cells would be used by one of skill based on the endogenous compound to be manipulated.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. The contents of all references cited throughout this application are hereby expressly incorporated by reference.

### Example 1

### Over-Expression of Ecto-Phosphatase does not Increase the Cellular Uptake of Adenosine

Transgenic Plant Construction: psNTP9 (Pisum sativum apyrase, GenBank accession #Z32743) was subcloned as a SalI to XbaI fragment into pKYLX71 (Schardl et al, 1987, supra.). This plasmid was transformed into A. tumefaciens GV3101 [pMP90] pKYLX71 (Koncz and Shell 1986), which was used to infect root calli from Ws ecotype Arabidopsis thaliana under kanamycin selection (Valvekens, et al., 1992). Four individual lines, obtained from separate calli, were propagated to the third generation (T3).

Subcellular Apyrase Distribution in Pea: Etiolated pea plumules served as the tissue source for nuclei and cytoplasm isolation as described by Chen and Roux (1986). Plasma membrane was prepared from 30 g of pea root tissue (Jun and Jia, 1995). Western analysis was performed on 15-30 μg of protein from cytoplasm, plasma membrane and nuclei using a polyclonal anti-apyrase antibody raised against the purified pea protein (Tong et al., 1993). To determine the orientation of the pea apyrase in the pea plasma membrane, outside-out vesicles were prepared (Short et al., supra.), and the accessibility of the enzyme was determined by selective trypsin proteolysis, or membrane shaving, followed by activity assays and western blotting.

Phosphate uptake experiments and growth assays: In all experiments the growth media did not contain sugar, and plants were grown in sterile culture at 22° C. under 150-200 μE of continuous light. Unless otherwise noted, a standard 0.8% agar medium (Becton Dickenson, Cockeysville, Md.) containing 100 μM phosphate was used for uptake assays (Somerville et al., 1982). Plants used for the phosphate uptake experiments were grown singly in 1 ml of the standard agar medium for 15 days prior to the experiment. On the day of the experiment, 10 μCi ³²P was applied to the side of the culture dish and allowed to diffuse through the agar. The lids of 95 mm×15 mm tissue culture dishes (Fisher, Pittsburgh, Pa.) were removed to facilitate transpiration. After 18 hours, the plants were removed from the medium. The aerial portions of the plant not in contact with the agar were weighed and counted by liquid scintillation. For each plant the entire root system was carefully pulled from the agar and washed in ice cold water prior to scintillation counting. To measure the transport of the products of ATP hydrolysis by the transgenic plants overexpressing apyrase and by wild-type plants, [2,8³H]ATP,.[³²P]ATP, and [³²P] ATP (Amersham) were fed to 15-day-old plants in separate treatments. All treatments were analyzed for significance in a T-test (n>4-6 for all groups, *P<0.05, error bars=s.e.m.).

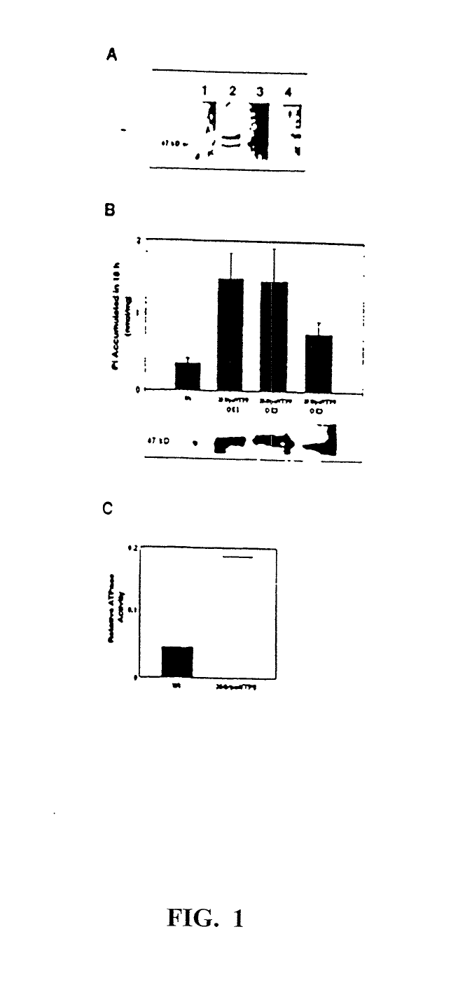

Detection of the pea apyrase in nuclei and in purified plasma membrane: By immunoblot assay, the pea apyrase was found to be associated with nuclei and with purified plasma membranes but not with the cytoplasm (FIG. 1A). The contents of the lanes in FIG. 1A are as follows: Lane 1, cytoplasm; Lane 2, purified plasma membrane; Lane 3, purified nuclei; and Lane 4, pre-immune control of nuclei. Protease treatment destroyed both apyrase activity and antigenicity in outside-out plasma membrane vesicles. After trypsin treatment, the exterior face of the vesicle showed 30% of the ecto-phosphatase activity of the untreated sample. Endophosphatase activities were retained after trypsin treatment, indicating that the digest occurred exclusively on the exterior face of the membrane. These data indicated that the ecto-apyrase was in fact being expressed in the extracellular matrix (ECM).

Enhanced Growth of Plants Over-Expressing Apyrase: Three of the four transgenic plant lines constitutively expressed psNTP9 under the control of the cauliflower mosaic virus 35S promoter and over an 18 hour period showed two to five times as much phosphate accumulation in shoots as wild type (FIG. lB); Top, the total phosphate accumulated in the shoots of three independent transformants in an 18 hour ³²P uptake assay at 2 mM phosphate; Bottom, a corresponding immunoblot performed on equal amounts of protein isolated from the ECM of three week-old wild-type Arabidopsis thaliana and the psNTP9 transgenics. Apyrase expressing plants also showed four times as much phosphatase activity in the extracellular matrix as the wild-type (FIG. 1C). (Note, OE1 in the figure stands for over-expression 1 transgenic line).

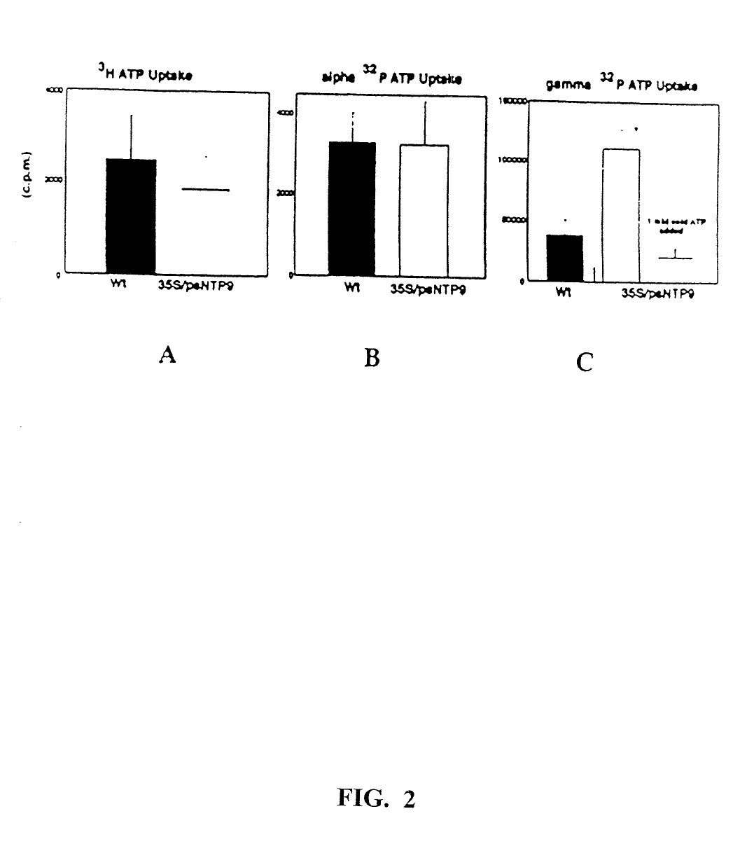

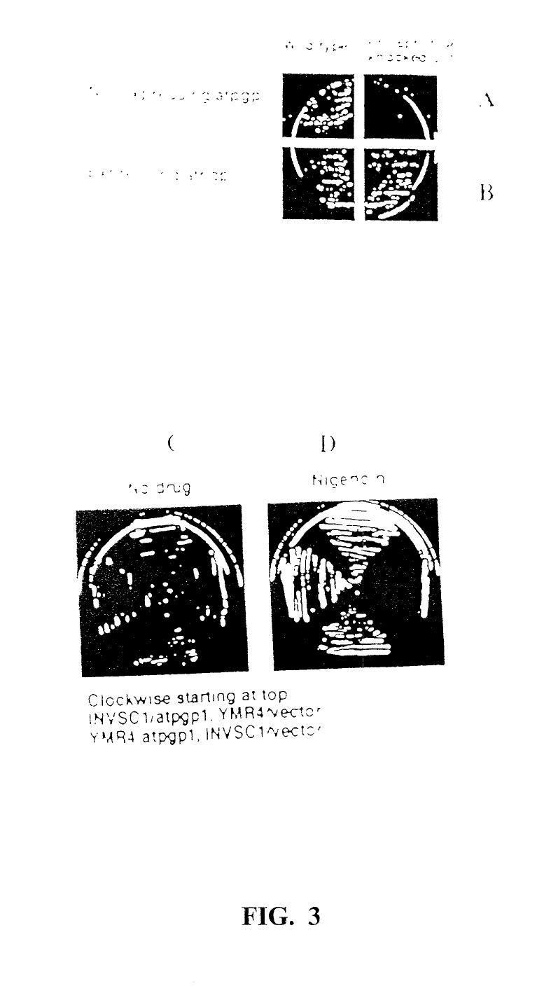

Transgenic plants preferentially transport the gamma phosphate of ATP: In order to address whether over-expression of ecto-apyrase was stimulating the adenosine salvage pathway, the intracellular uptake of adenosine was measured both in the presence and absence of the over expression of apyrase. The inability of apyrase to translocate either extracellular AMP or adenosine was demonstrated by the low level of radiolabel accumulated in the transgenic plants fed [2,8³H]ATP and.[³²P]ATP (FIG. 2). The complete dephosphorylation of [2,8³H]ATP would result in a radiolabelled adenosine molecule while the complete dephosphorylation of .[³²P]ATP would result in a non-labeled adenosine label. FIG. 2A illustrates that plants overexpressing apyrase did not translocate radiolabelled adenosine (or byproducts of the dephosphorylation of [2,8³H]ATP) any more efficiently than plants not overexpressing apyrase (wild-type plants). FIG. 2B illustrates that plants overexpressing apyrase did not translocate AMP (or the byproducts of the dephosphorylated .[³²P]ATP) any more efficiently than wild-type plants. In comparison, feeding experiments where the. phosphate was labeled, the transgenics accumulated three times the amount of labeled phosphate as the wild-type (FIG. 2C). These data show that the over-expression of apyrase does not induce an increase in the uptake of adenosine and therefore its over-expression does not act to stimulate the adenosine salvage pathway.

### Example 2

### Ecto-Phosphatase is Involved in Drug Resistance in Yeast and Plants

Expression of AtPGP-1 in yeast: The AtPGP-1 cDNA (Arabidopsis thaliana MDR gene, accession #X61370) was subdloned into pVT101 downstream of the ADH promoter to create the AtPGP-1/pVT101 construct. AtPGP-1/pVT101 and pVT101 were transformed into Saccharomyces cerevisiae INVSC1 (genotype: MAT, his3-1, leu2, trp1-289, ura3-52) and YMR4 (genotype: MAThis3-11,15, leu2-3, 112ura35, can Res pho5, 3::ura31) by a PEG lithium acetate procedure (Eble, 1992) and selected on uracil dropout medium.

Yeast Growth: Yeast were grown at 30° C. under conditions of constant selection for uracil auxotrophy. YNB (Bio101, Vista, Calif.) supplemented with CSM (uracil dropout) and 2% glucose was used to grow strains having pVT101 constructs. Cycloheximide (Sigma Chemical, St. Louis, Mo.) was added to liquid media or spread on solid media to achieve a final concentration of 500 ng/ml. Nigericin (Sigma Chemical, St. Louis, Mo.) was added to liquid media or spread on solid media to achieve a final concentration of 25 μg/ml. Yeast strains used in cycloheximide selection assays were always propagated in the presence of the cycloheximide on plates and then streaked onto new plates containing drug or no drug, such that induced resistance existed in each strain at the time of the start of the assay. For selection assays on plates, single colonies were streaked; for selection in liquid media 0.01 ml of saturated culture was added to fresh media containing the drug. The plates shown in figures were grown for 3-5 days before photographs were taken. Yeast selection assays in liquid media were quantitated by turbidity as measured by absorbance at OD₆₀₀.

Expression of apyrase and AtPGP-1 in plants: The expression of apyrase in plants is as described above in Example 1. Similar methods were employed to express AtPGP-1 in Arabidopsis thaliana plants with the following modifications. The AtPGP-1 coding region was subcloned into a pBIN vector lacking the GUS gene as described in Sidler, et al., 1998, The Plant Cell 10:1623-1636. This plasmid was then transformed into A. tumefaciens as described above, which was used to infect root calli to produce transgenic plants expressing AtPGP-1. Plant growth: Arabidopsis thaliana seeds were sown in a solid germination media containing MS salt, 2% sucrose, 0.8% agar, and vitamins (Valvekens et al., 1992). For selection assays, cycloheximide was spread on the media to achieve a final concentration of 250 ng/ml. Plant growth was measured by germination percentage after 6-30 days.

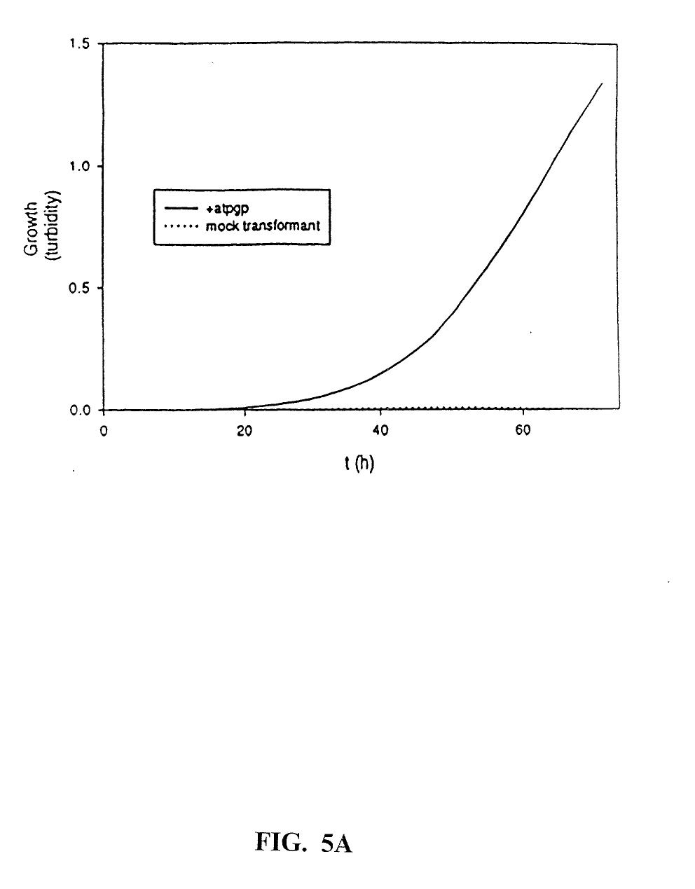

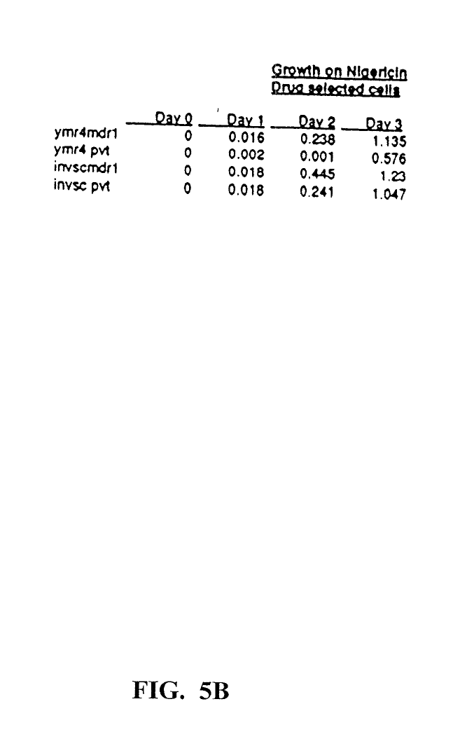

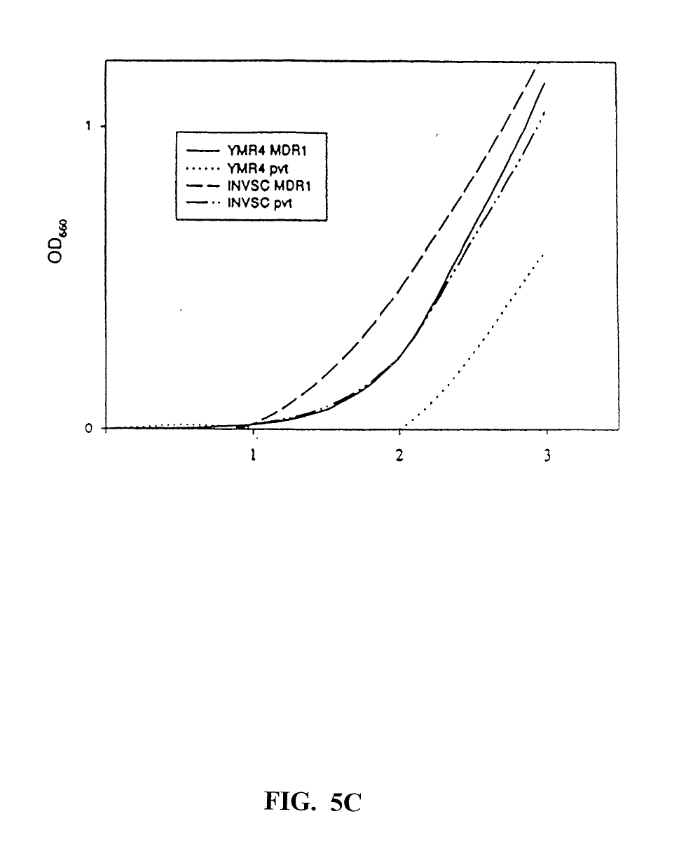

Effect of over-expression of AtPGP-1 in yeast: When a yeast mutant, YMR4, which is deficient in two major extracellular phosphatases and tends to accumulate ATP extracelluarly, was grown in a potent cellular toxin, cycloheximide, it did not grow whereas a wild-type yeast strain, INVSC1, did grow in the presence of cycloheximide (FIG. 3A). Surprisingly, expression of the plant multidrug resistance (MDR) gene, AtPGP-1, enabled the yeast mutant to grow in the toxin (FIG. 3B and FIG. 5A). The presence of AtPGP-1 in the wild-type yeast did not have any effect when grown in the presence of cycloheximide (FIG. 3B). The same result was obtained when the yeast strains were cultured in nigericin (FIG. 3C, FIG. 3D, FIG. 5B, FIG. 5C). In FIG. 3C and 3D, starting from the top of the dish clockwise, the cells are as follows: INVSC1 (wild-type) overexpressing AtPGP-1, YMk4 containing the vector alone, YMR4 overexpressing AtPGP-I, and INVSC1 containing the vector alone. When grown without drug, all the cells grow (FIG. 3C). However, when grown in drug, only the YMR4 containing vector alone shows reduced growth. The survival of the AtPGP-1 transformed strains was due to the ability of the MDR1 channel to efflux the toxin, hence lowering the actual cellular concentration of the poison cycloheximide. The sensitivity of the untransformed mutant to the drug is likely due to a loss of the ATP gradient below a point at which endogenous transporters, similar to ATPGP-1 can function.

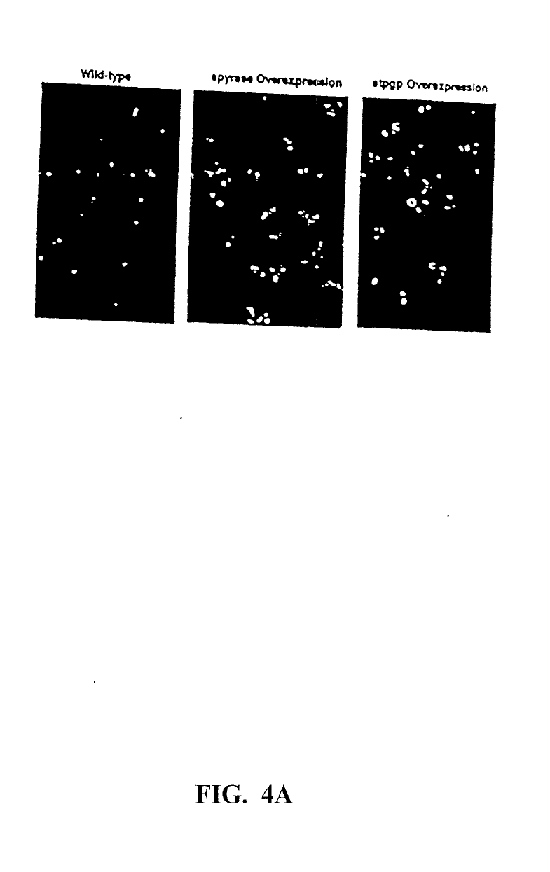

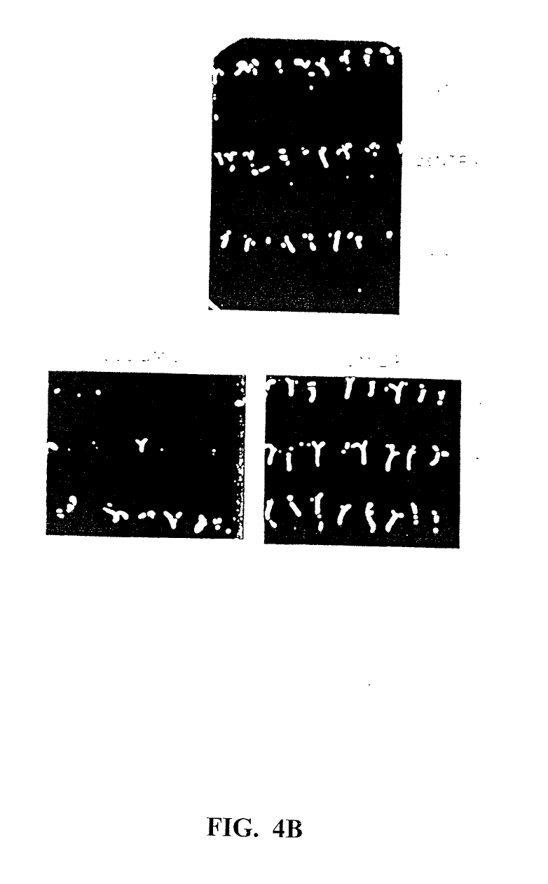

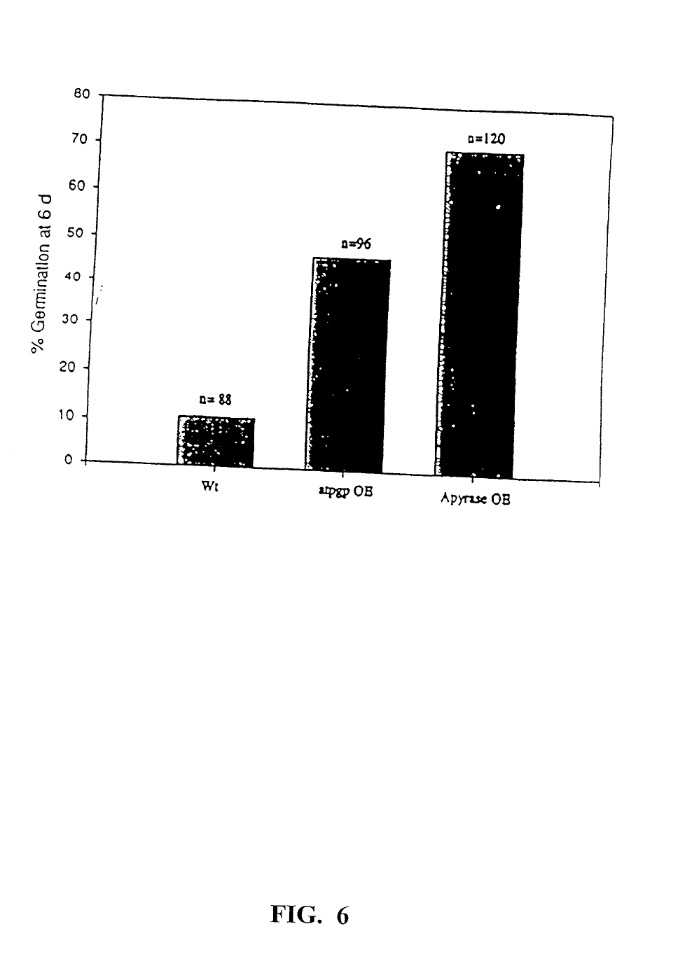

Effect of over-expression ofAtPGP-1 in plants: The over-expression of AtPGP-1 was able to confer resistance to cycloheximide in plants (FIG. 4A and FIG. 6) and to the cytokinin, N₆-(2isopentenyl) adenine (2IP) (FIG. 4B). These results had not been observed previously and in fact, the prior art actually teaches away from this finding suggesting that over-expression of plant AtPGP-1 is not involved in drug resistance. See Sidler et al. (1998). Therefore, this result was particularly unexpected in plants. Additionally, since Arabidopsis plants overexpressing AtPGP-1 are able to grow in both cycloheximide and cytokinin, this suggests that the conference of drug resistance by AtPGP-1 is likely to be seen with other chemicals as well and is not an isolated phenomenon.

Effect of over-expression of apyrase on drug resistance in plants: Another unexpected result was obtained when the plant apyrase gene was over-expressed in plants. Over-expression of apyrase in plants resulted in the conference of resistance to cycloheximide (FIG. 4A and FIG. 6). The same result was obtained when the plants were grown in the presence of a cytokinin, N₆-(2isopentenyl) adenine (FIG. 4B). In fact, over-expression of apyrase is surprisingly able to raise the germination rate above the level obtained by the over-expression of the MDR gene AtPGP-1 (FIG. 4A, FIG. 4B and FIG. 6). Just as under-expression of phosphatase activity in a yeast mutant lacking two potent extracellular phosphatases diminished its resistance to cycloheximide (FIG. 3A), over-expression of a powerful extracellular ATP phosphatase in plants bolstered resistance. The fact that higher resistance was found in plants genetically manipulated only with respect to phosphatase over-expression and not MDR1, indicates that there likely exists other ATP-symporters used in detoxification in addition to MDR1. Minimally, the stronger ATP gradient set up by apyrase in the transgenic plants affects the kinetics of the wild-type MDR1.

### Example 3

### ATP Efflux in Yeast and Plants Overexpressing AtPGP-1

ATP collection: Yeast cells used in the luciferase assays were grown for two days and then transferred to fresh media at the time of the assay. From this time forward, the cells were kept at room temperature on a rotator. Every hour a 1 ml aliquot was taken, the cells in the aliquot were counted on a hemocytometer, a methylene blue viability assay was performed (Boyum and Guidotti 1997), the cells were centrifuged, and the supernatant was stored in liquid nitrogen until all the aliquots were collected. For luciferase assays involving plants, Arabidopsis thaliana plants were grown in sterile culture at 22° C. under 150-200 μE of continuous light for at least 15 days. Foliar ATP was collected by placing a single 30 μl drop of luciferase buffer (Analytical Luminescence Laboratory, Cockeysville, Md.) on a leaf and, without making direct physical contact with the plant, the droplet was immediately collected and snap frozen. For each leaf, the area was approximated as an integrated area of a 2-D image of the leaf using NIH1.52 software (Shareware, NIH).

Luminometry: Samples were reconstituted to a 100 μl final volume in Firelight™ buffer (Analytical Luminescence Laboratory, Cockeysville, Md.). After the buffer was added, all samples were kept on ice. ATP standards were reconstituted in 100 μl of Firelight™ buffer and the standards and sample were loaded into a 96-well plate and read on an automated Dynex Technologies Model MLX luminometer (Dynex Technologies, Chantilly, Va.). Samples were processed with the addition of 50 μl of Firelight™ enzyme (Analytical Luminescence Laboratory, Cockeysville, Md.) followed by a reading delay of 1.0 second and an integration time of 10 seconds. Output was taken as an average for the integration time and then averaged for multiple samples. The sample handling time was less than 2 hours.

Pulse Chase experiments: Yeast were grown to saturation in liquid medium, as described above, centrifuged, and resuspended in fresh medium containing 1 μCi/ml ³H-adenosine (Amersham, Arlington Heights, Ill.). The cells were rotated at room temperature for 20 minutes to allow adenosine uptake. After 20 minutes the cells were centrifuged. The pellet was washed twice in ice cold medium, resuspended in culture medium at room temperature, divided equally between five types (five per cell line), and placed on a rotator. Every ten minutes a separate tube from each cell line was centrifuged and the pellet and supernatant were placed in separate scintillation vials. The efflux activity was expressed as the ratio of counts in the supernatant to counts in the pellet.

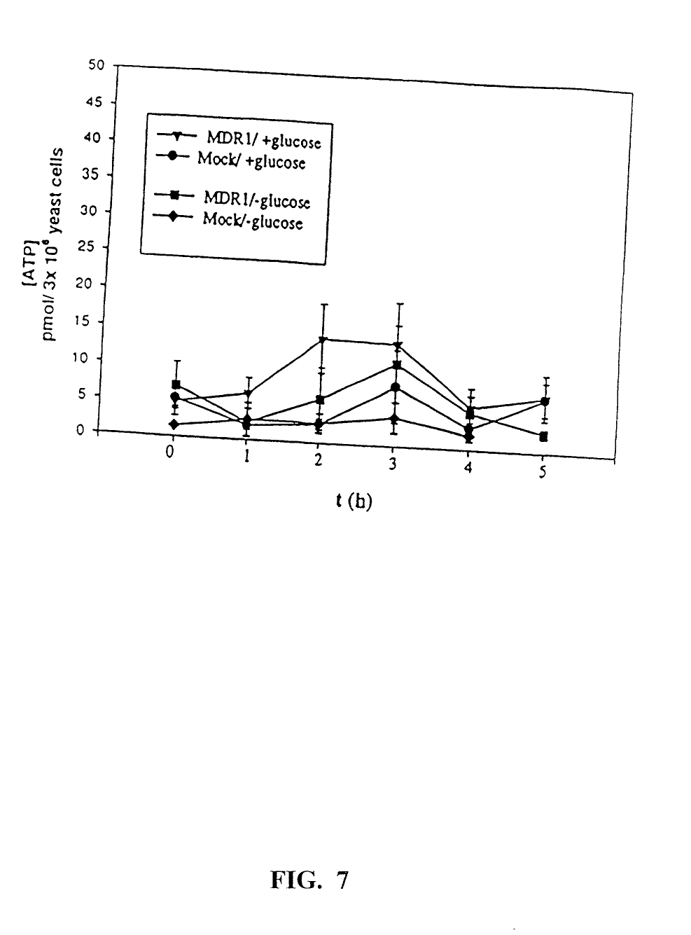

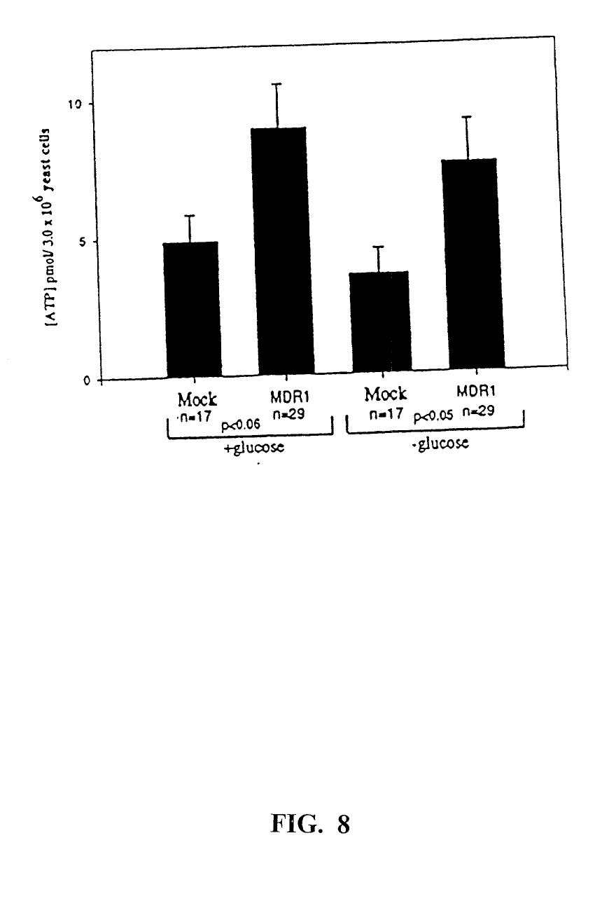

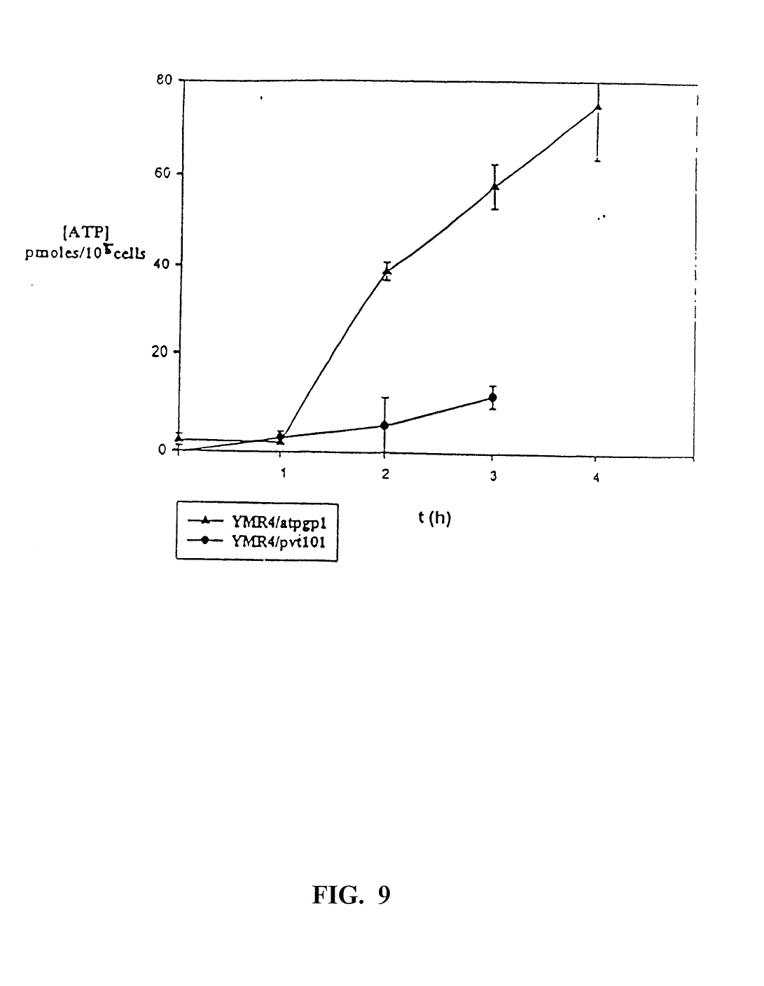

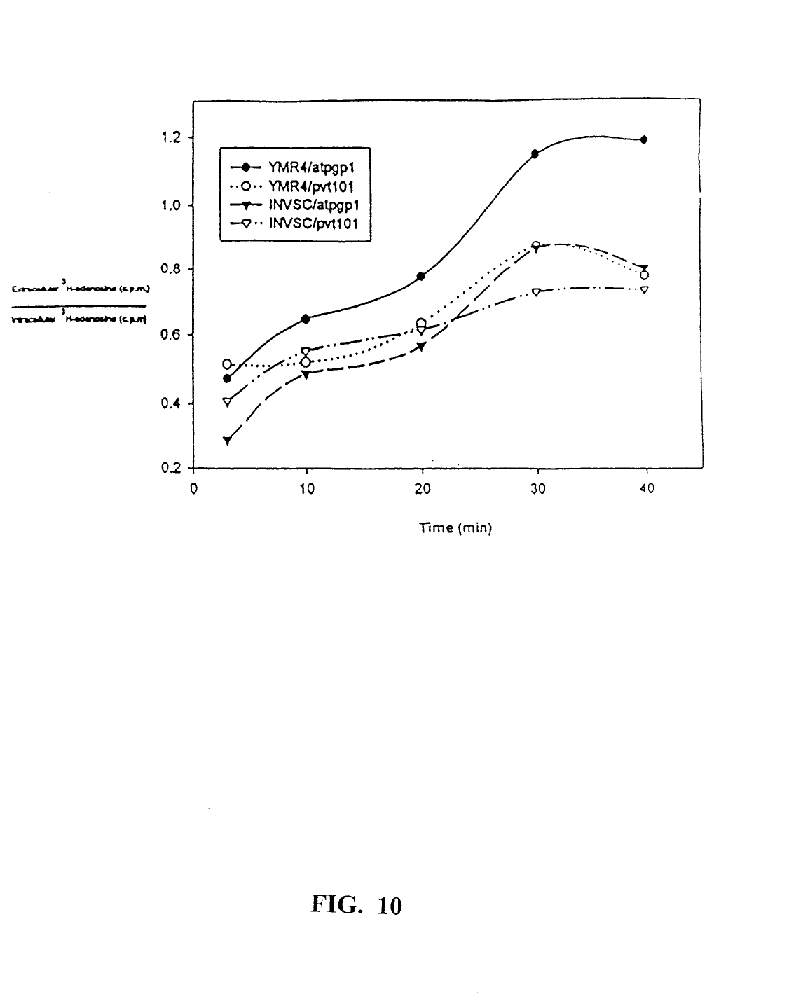

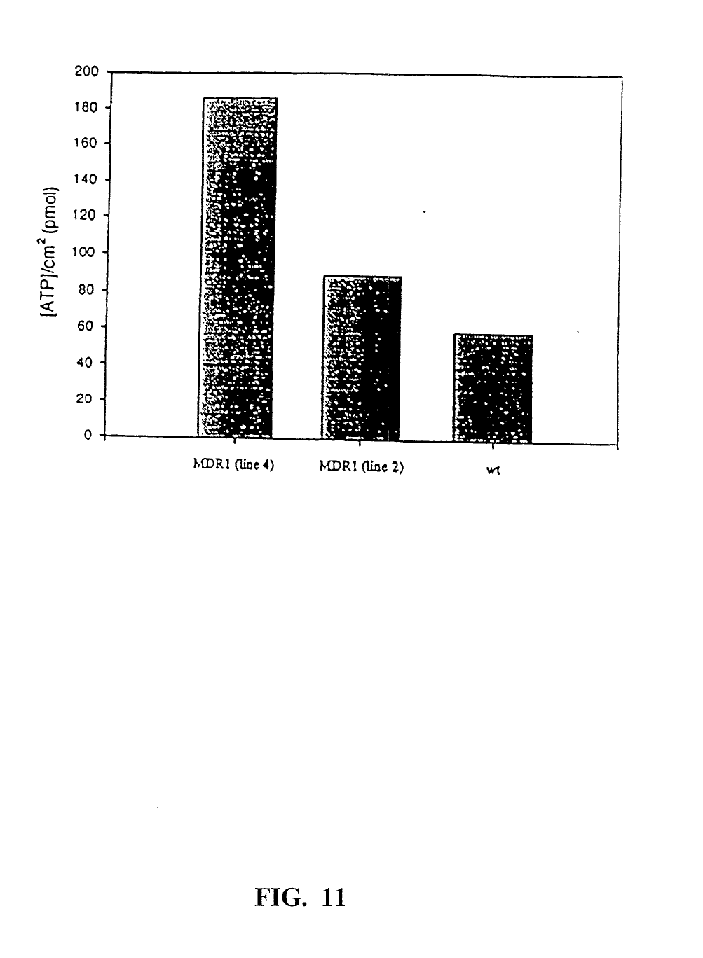

The ATP effluxed by the plant MDR1, AtPGP-1, over-expressed in yeast: In wild-type cells there is a steady-state level of ATP in the extracellular fluid, which is to say that the ATP outside the cells is rapidly degraded by phosphatases and does not accumulate over time (FIG. 7). However, the expression of the AtPGP-1 doubled this steady-state level (FIG. 8). If the yeast mutant, YMR4, which is deficient in extracellular phosphatase activity, is analyzed, there was a noticeable accumulation of ATP in the extracellular fluid compared to a control mutant transformed with empty plasmid pVT101 (FIG. 9). In addition to ATP measurements based on luminometry performed on a kinetic time-scale of hours, an earlier differential ATP efflux in MDR1 expressing cells by pulse chase experiments was demonstrated (FIG. 10). Furthermore, Arabidopsis thaliana plants from two independently transformed lines, that constitutively express the AtPGP-1 protein, showed a significant accumulation of ATP on their leaf surfaces (FIG. 11). Taken together, these data demonstrate the absolute ability of plant MDR1, AtPGP-1, to transport ATP from inside the cell to the outside. Moreover, these data show that ATP efflux channels and phosphatases both have roles in the steady-state level of ATP outside of the cell. This is the first demonstration of the importance of extracellular ATP steady-state levels, and the importance of an ATP gradient across biological membranes in the modulation of drug resistance.

### Example 4

### A Two-Component System is Found in Arabidopsisplants

Plant Growth: Arabidopsis seeds were sown in a solid germination media containing MS salts (Sigma Chemical, St. Louis, Mo.), 2% sucrose, 0.8% agar, and vitamins (Valvekens et al., 1992). For selection assays, one of the following, or a combination of both, was added to media (cooled to less than 50° C. before adding) immediately prior to pouring into plates: cycloheximide at a final concentration of 500 ng/ml; α,β-methyleneadenosine 5′-diphosphate at a final concentration of 1 mM. Plant growth was measured by germination percentage after 10-20 days. All other materials and methods were discussed above in Example 2.

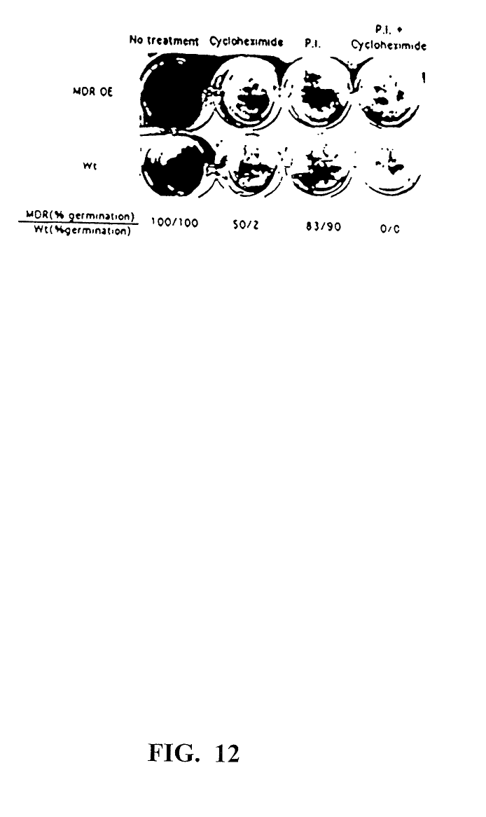

Effects of phosphatase inhibitor on plants overexpressing AtPGP-1: FIG. 12 shows that when wild-type and AtPGP-1 overexpressing (MDR OE) Arabidopsis thaliana plants were either treated with nothing (lane 1), cycloheximide (lane 2), α,β-methyleneadenosine 5′-diphosphate (phosphatase inhibitor) (lane 3), or cycloheximide and phosphatase inhibitor (lane 4), both the wild-type and the AtPGP-1 overexpressing plants were affected similarly by the presence of phosphatase inhibitor. While the AtPGP-1 overexpressing plants grew significantly better in the presence of cycloheximide alone with a 50% germination rate for the AtPGP-1 overexpressing plants and a 2% germination rate for the wild-type plants, similar germination rates were seen for both the AtPGP-1 overexpressing and wild-type plants in the presence of either phosphatase inhibitor alone (83% and 90% germination respectively) or cycloheximide plus phosphatase inhibitor (no germination at all). The addition of phosphatase inhibitor surprisingly destroys the ability of the AtPGP-expressing plants to grow in the presence of cycloheximide. These data suggest that phosphatases are involved in the conference of drug resistance in plants and that there is a two-component system similar to that demonstrated in yeast in Example 2 and 3 above in which an MDR-like protein and an ATP-gradient-maintaining ecto-phosphatase are important in modulating drug resistance.

### Example 5

### The ATP Gradient Directly Effects Drug Resistance in Cells

Cell lines: Cell lines were the same as those described above in Example 2 and 3. YMR4 MDR1 is the phosphatase mutant yeast strain overexpressing AtPGP-1; YMR4 pVT11 contains vector alone; INVSC MDR1 is the wild-type yeast strain overexpressing AtPGP-1; and INVSC pVT101 contains vector alone.

Selection in drug: To create drug resistant yeast strains, all four cell lines were grown up in the presence of 500 ng/ml of cycloheximide, and transferred to other cycloheximide containing plates after a period of four to six days. This transfer of cell lines and subculturing continued such that the yeast cells grew in the presence of cycloheximide for a period of at least a month.

Cells cultured in media alone: To create cell lines that had not been preselected for their ability to grow in drug, yeast strains were grown on plates containing YNB (Bio101, Vista, Calif.) without uracil (-URA) to maintain the presence of the vector (which supplies URA) without any drugs added.

Growth of cells in suspension for ATP and drug selection experiments: Cells were transferred into 5 ml YNB -URA liquid media for turbidity measurements. All cell lines (both non-drug selected and drug-selected) were grown in media with the addition of either nothing, 500 ng/ml cycloheximide, 100 mM ATP, or 500 ng/ml cycloheximide and 100 mM ATP. Turbidity readings were taken after 48 hours.

Growth of cell lines in suspension for salvage pathway experiments: All cell lines were grown in liquid media either containing drug (for the drug selected lines) or not containing drug (for the non-drug selected lines). When the cultures reached a turbidity of 1.00 as measured at a wavelength of 600 in a spectrophotometer (OD₆₀₀=1.00), 10 μl of each culture was then removed and placed in either media with nothing added, 3 mM potassium phosphate; 3 mM adenosine; 9 mM potassium phosphate and 3 mM adenosine (for controls); potassium phosphate and cycloheximide; adenosine and cycloheximide; adenosine, cycloheximide, and potassium phosphate. Cell cultures were further grown for 72 hours, and their turbidity was determined by OD₆₀₀ readings on a spectrophotometer.

Growth of cell lines for nigericin experiments: Drug selected lines were removed from cycloheximide containing plates and placed in 5 ml liquid media containing 5 ng/ml cycloheximide. Cell cultures were allowed to grow until they reached an OD₆₀₀ reading of 1.00, and then 10 μl from each culture was removed and transferred to culture tubes containing 5 ml of liquid media and 25 μg/ml nigericin OD₆₀₀ readings were recorded daily for a period of up to 72 hours to determine growth.

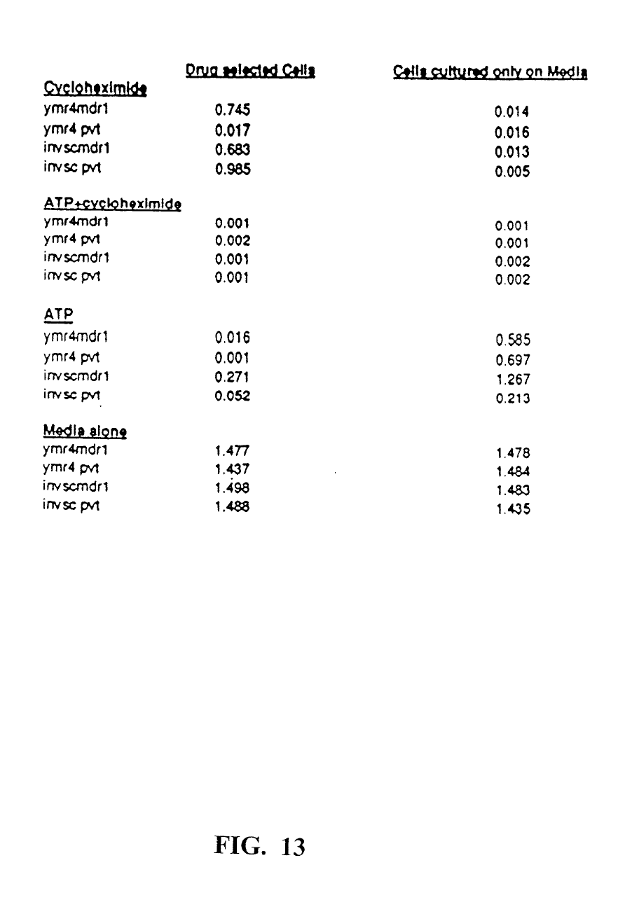

An ATP gradient is critical in MDR: The importance of the ATP gradient in MDR in yeast cells was demonstrated by showing that the growth of cells which were previously grown in drug and had developed resistance to the drug, were not able to grow in high levels of ATP unless they were overexpressing AtPGP-1 (FIG. 13). Cells which had not been previously selected in drug were able to grow in the presence of high levels of ATP (FIG. 13). These data emphasize that the loss of an ATP gradient is previously resistant cell lines abolishes resistance. This result is new to the understanding of MDR and has led to vast insight into the understanding of the mechanism by which MDA-ABC transporters confer resistance to cells and to methods to modulate such resistance. Moreover, when cells were grown in high levels of ATP and drug (cycloheximide), even the cell lines which had previously showed resistance to drug were unable to grow in the presence of drug and ATP. These data indicate that when the ATP gradient across biological membranes is destroyed (by the presence of high extracellular levels of ATP), efflux of drugs cannot be achieved and therefore, drug resistance is abolished. In summary, the multi-drug resistance channel is not functional without an ATP gradient.

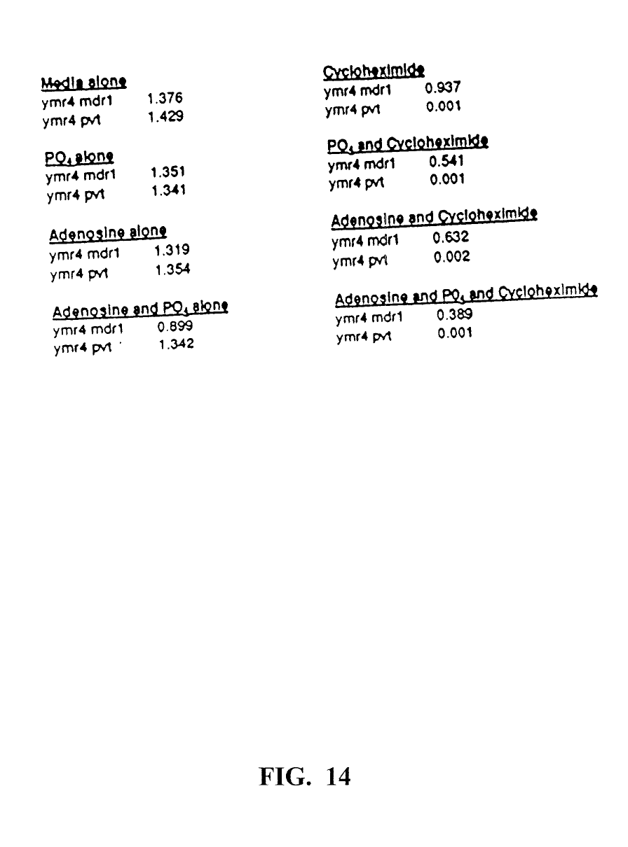

The drug resistance is not due to an adenosine salvage pathway: In order to address whether the involvement of a nucleotide salvage pathway was responsible for the results of the present invention, yeast cells were cultured in the presence of extracellular adenosine and extracellular phosphate. The acid phosphatase yeast mutant, YMR4, was selected because its decreased ecto-phosphatase activity makes it an ideal candidate for studying the effect of extracellular nucleotides on growth. If an adenosine salvage pathway were involved, then the presence of extracellular adenosine or possibly phosphate should help cells recoup the intracellular ATP losses due to ATP/drug efflux and should help cells grow in the presence of drug whether or not the cells were overexpressing AtPGP-1. In contrast, however, the addition of adenosine or phosphate to the media did not enhance resistance to the cells (FIG. 14). In fact, cells overexpressing AtPGP-1 grew best in drug alone, with the addition of adenosine and/or phosphate being slightly inhibitory. Furthermore, cells which did not express AtPGP-1 were unable to grow in drug regardless of the presence of adenosine and/or phosphate. These data suggest that an adenosine salvage pathway is not the principal mechanism at work in the present invention.

### Example 6

### High Throughput Screen for Isolating Apyrase Inhibitors

Small Molecule Library: A small molecule library (DIVERSet format F), which was specifically constructed to maximize structural diversity in a relatively small library (9600 compounds), was obtained from ChemBridge Corporation (San Diego, Calif.). The small molecules (supplied in 0.1 mg dehydrated aliquots) were dissolved in DMSO, transferred to a 96 well plate, and tested for their ability to inhibit apyrase activity.

The assay: A stringent screen to test the ability of small molecules to disrupt the ATPase activity of the apyrase enzyme was developed based on phosphate-mobylate complexation. The assay was a modification of a phospholipase assay developed by Hergenrother et al. (1997). Under normal conditions, the apyrase enzyme liberates phosphate from ATP present in the reaction. The liberated phosphate quickly forms a complex upon addition of a small amount of acidified molybdate and ascorbate allowing for the production of a very dark blue color (the less phosphate liberated, the less blue color). Control reactions were performed with heat inactivated apyrase enzyme. Color intensity was detected on an Alpha Imager 2000 with AlphaEase™ software (Alpha Innotech, San Leandro, Calif.). Color changes were also evident by the naked eye. A Biomek 2000 robot (Beckman, Fullerton, Calif.) was used for screening the 9600 samples.

To each well of the 96 well plates containing a small molecule from the library, 100 μl of reaction buffer (60 mM HEPES, 3 mM MgCl₂, 3 mM CaCl₂, 3 mM ATP pH 7.0) was added. The apyrase (potato apyrase grade VI, Sigma Chemical, St. Louis, Mo.) enzyme (0.1 units) was added in a 5 μl volume and the reaction was allowed to proceed at room temperature for 60 minutes.

Three buffers were used to visualize activity

Buffer A: 2% Ammonium molybdate in water

Buffer B 11% Ascorbic acid in 37.5% aqueous TCA.

Buffer C: 2% trisodium citrate, 2% acetic acid.

Immediately before developing the assay, buffers A and B were mixed in a 1:1.5 ratio. 50 μl of A:B was added to each well. The 96 well plate was then vibrated on a table surface to mix the solution. The deep blue color developed after approximately 2 minutes. After 2 minutes, 50 μl of buffer C was added to each well and the blue color became darker, increasing the sensitivity of the assay. The color intensified for up to one hour with no accompanying color change in the control wells containing heat inactivated apyrase enzyme. The color intensity for a single plate was measured on an Alpha Imager 2000 with AlphaEase™ software (Alpha Innotech, San Leandro, Calif.).

Nineteen positives were identified from the 9600 compound DIVERSet library.

### Example 7

### Identification of Adjuvants Among Ecto-phosphatase Inhibitors

Compounds identified as ecto-phosphatase inhibitors were tested for adjuvant activity.

Increasing Plant Sensitivity to Herbicides: Arabidopsis thaliana WS wild-type plants were plated on germination media containing two commonly used herbicides, surflan and pendimethalin, in the presence and absence of an ecto-phosphatase inhibitor of Formula II and monitored for their growth in a 22° C. incubator under constant fluorescent illumination.

More specifically, germination media was prepared containing 20 μl/ml, 10 μl/ml, 2 μl/ml, 1 μl/ml, and 0.2 μl/ml of a surflan solution made at the manufacturer's recommended concentration. Compound of Formula II was added to a portion of the germination media at a final concentration of 5 μg/ml.

Arabidopsis thahiana WS wild-type seeds were surface sterilized in a 20% bleach solution for 20 minutes, washed three times in double distilled waster, and resuspended in 0.1% agarose solution. The seeds were then pipetted onto plates containing approximately 3 ml of germination media containing the various concentrations of surflan with and without compound of Formula II. All plates were placed in a 22° C. incubator under constant fluorescent illumination. Growth was assessed daily. Results showed that surflan was an equally effective weed killer at a five fold less concentration in the presence of compound of Formula II.

Similar experiments were performed with pendimethalin in the presence and absence of compound of Formula II. These experiments yielded similar results. These results indicate that ecto-phosphatase inhibitors can increase the effectiveness of herbicides, thereby decreasing the amount of such compounds necessary to produce the desired biological effect.

Increasing Yeast Sensitivity to Fungicide. Additional experiment were performed to test the ability of ecto-phosphatase inhibitors to increase the effectiveness of the commonly used fungicide chlorothalonil. Yeast was plated on media with or without an ecto-phosphatase inhibitor of Formula X where a paper filter disk soaked in the fungicide was added to the plate. After 48 hours, the zone of inhibition of yeast growth around the filter disk was calculated.

The wild-type yeast strain INVSC with plasmid pvtl01-U (for selection on media lacking uracil) was used in all experiments and each experiment was performed in triplicate. Media used was made by combining YNB (Bio 101, Vista, Calif.), the drop out supplement CSM-URA (Bio 101, Vista, CA), and glucose in water. Media was made to pH 5.8 and 17 g/L agar was used as a solidifying agent. A stock solution of 20 mg/ml in DMSO of ecto-phosphatase inhibitor of Formula X was prepared and an amount added to the plates to give a final concentration of 5 μg/ml. Plates lacking ecto-phosphatase inhibitor contained an equivalent amount of DMSO as a control.

Twenty μl of an overnight saturated culture of yeast was plated onto each plate, spread, and allowed to dry for 20 minutes. Filter disks were punched from Fisherbrand filter paper and crosslinked at 500 mjoules in a UV Stratalinker 2400 (Stratagene, La Jolla, Calif.). Disks were dipped in concentrated chlorothalonil (Lawn and Garden Fungicide-12.5% chlorothalonil, Black Leal, Buckner, Ky.) and the disk was placed in the center of the plate. No disk controls were also tested. All plates were placed in a 30° C. incubator. The zone of inhibition of yeast growth around the disk was assessed after 48 hours.

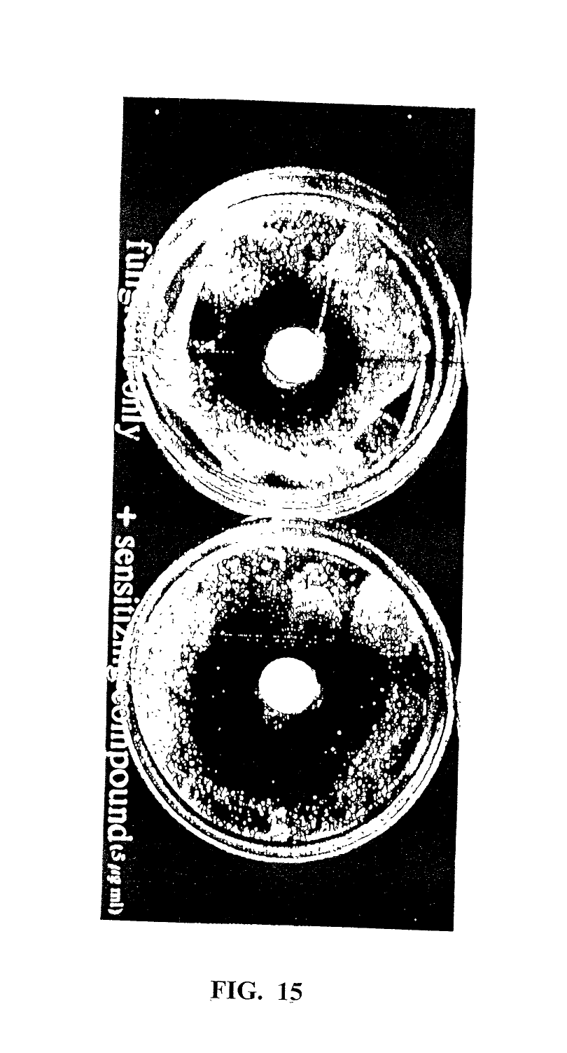

Control plates with ecto-phosphatase inhibitor only showed that yeast grew to confluence on the media containing only the ecto-phosphatase inhibitor. Plates with chlorothalonil disks indeed contained a zone of inhibition surrounding the disk. As seen in FIG. 15, the zone of inhibition was about 50% larger on plates containing the ecto-phosphatase inhibitor compound of Formula X. These results illustrate that compound of Formula X can serve to increase the effectiveness of the fungicide chlorothalonil. The zone of inhibition was calculated by measuring the radius from the center of the disk to the point of noticeable yeast growth (at least 10 measurements per plate), averaging the radii measurements, and using the average radius of the plates to calculate the circular area of the zone of inhibition. The average radius of inhibition of plates without ecto-phosphatase inhibitor was 0.33 in., while the average radius of plates with inhibitor was 0.41 in. These gave areas of inhibition of 0.35 in for chlorothalonil by itself and 0.54 in² for clorothalonil in the presence of compound of Formula X. Thus the presence of the ecto-phosphatase inhibitor increased the growth inhibitory effect of chlorothalonil by over 50%.

### Example 8

### Suramin as an Ecto-phosphatase Inhibitor

Increasing Bacterial Sensitivity to Antibiotics: A single colony of bacteria or yeast will be grown overnight to saturation in the appropriate liquid media. A 200 μl aliquat of the bacteria or yeast will be spread on the surface of a bacterial plate containing growth media and a filter disk soaked in an antibiotic, in the presence or absence of an ecto-phosphatase inhibitor of Formula XX (i.e., suramin). Plates will be incubated at approximately 37° C. for about 20-24 hours. After incubation the microbial growth on each plate will be assessed.

The presence of concentrated antibiotic solution on the filter disk in the center of the plate produces a zone of growth inhibition surrounding the disk. The area of this inhibition zone is dependent on the sensitivity of a particular microbial strain to the antibiotic being tested. The effective concentration of the antibiotic is decreased as the distance from the disk is increased. Thus, a microbial strain with increased resistance to a particular antibiotic will have a smaller zone for inhibition compared to a microbial strain that is more sensitive to the antibiotic. Each microbial strains will be tested on plates in the presence of antibiotics to which that particular strain has a previously characterized resistance, such as Pseudomonas with resistance to MexA and Candida with resistance to CDR1. Each strain will then be tested in the presence of the same antibiotic and in the presence of suramin at various concentrations. The effectiveness of suramin in reducing antibiotic resistance will be determined by comparing the zone of inhibition of bacterial growth on plates with the antibiotic alone and plates containing antibiotic and suramin. Suramin will be judged as effective if the zone of inhibition is significantly increased in the presence of suramin. Plates of the microbial strain will be grown under identical conditions in the presence of suramin alone to determine the growth inhibitory properties of suramin on each strain. All experiments will be performed in triplicate.

Determining Minimum Inhibitory Concentration (MIC) of Antibiotic in Presence of Suramin: Additional experiments will be performed to test the ability of ecto-phosphatase inhibitors to increase the effectiveness of certain anti-infectives.

Microbial strains (either bacteria or yeast) will be plated on media plus LB and an anti-infective, with or without an ecto-phosphatase inhibitor of Formula XX, to determine the effect of suramin. Suramin is commercially available from Sigma, St. Louis, Mo. A 1 mg/m stock solution will be prepared in a solvent such as DMSO.

The Minimum Inhibitory Concentration (MIC) of each anti-infective with each microbial strain will be determined. Each microbial strain will be tested using a series of dilutions of the appropriate anti-infective and suramin. Approximately 2000 microbial cells of a saturated overnight culture of bacteria will be added to each serial dilution of anti-infective and the total volume split into two 0.5 ml aliquots. To one series of aliquots suramin will be added to a final concentration of 10-60 μg/ml. The other series will receive an equal volume of solvent. A third set of plates will be incubated in the presence of suramin alone without the anti-infective.

All plates will be placed at 37° C. and growth measured in the presence and absence of suramin at time intervals ranging from about 20 to 40 hours. Growth will be assessed by measuring the OD₆₀₀.

Experimental results from experiments involving treatment with a combination of anti-infective and suramin, anti-infective alone and suramin alone will be compared. Suramin will be judged to be effective if the MIC is significantly reduced using the combination treatment of the anti-infective and suramin versus the anti-infective alone. Each experiment will be performed in triplicate and significant differences in the growth determined by student's T-tests. The MIC tests will be used to determine if suramin acts to reduce resistance of microbials to certain anti-infectives, which anti-infectives suramin is effective with, and the minimal effective concentrations of both the anti-infective and suramin in inhibiting microbial growth.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

U.S. Pat. 4,880,918.

Abraham, et al., Proc. Natl. Acad. Sci. USA, 90:312-316, 1993.

Al-Awqati, Science, 269:805-806, 1995.

Bissinger, and Kucher, J. Biol. Chem., 269:4180-4186, 1994.

Boyum and Guidotti, Microbiology, 143: 1901-1908, 1997.

Che, J. Biol. Chem., 267:9684-9688, 1992.

Dhamant et al., J. Med. Chem., 35:2481-2496, 1992.

Dudler, and Hertig, Journal of Biological Chemistry, 267:5882-5888, 1992.

Eble, Biotechniques, 13:18-20, 1992.

Hergenrother et al.I, Lipids, 32:783-788, 1997.

Higgins, Cell, 82:693-696, 1995.

Huang et al., Biochem. Biophys. Res. Commun., 182:836-843. 1992.

In: Remington 's Pharmaceutical Sciences, 17^{th} ed., Mack Publishing Co., Easton, Pa.

Jun and Jia, Acta Botanica Sinica, 37:942-949, 1995.

Kolacskowski et al., J. Biol. Chem., 271:31543-31548, 1996.

Koncz, and Shell, Mol. Gen. Genet., 204:383-396, 1986.

Marti, et al., British J. of Pharmacology, 118:1232-1236, 1996.

Medina et al., Bioorg Med. Chem. Lett, 8:2653-2656, 1998.

Meyers, Encyclopedia of Molecular Biology and Molecular Medicine, 6: 125-133, 1997.

Plesner, Int. Rev. Cyto., 158:141-214, 1995.

Schardl et al, Gene, 61(1):1-11, 1987.

Schweibert, Cell, 81:1063-1073, 1995.

Sedaa, et al., J. Pharmacol. Exp. Ther., 252:1060-1067, 1990.

Senior, et al., FEBS Letters, 377:285-289, 1995.

Short et al., supra.

Sidler, et al., The Plant Cell, 10: 1623-1636, 1998.

Somerville, et al., In: Methods in Chloroplast Biology, Elsevier Biomedical Press, Amsterdam, pp 129-138, 1982.

Tong, et al., Plant Physiol, 101:10005-1011, 1993.

Ujhazy et al, Ins. J. Cancer, 68:493-500, 1996

Urtban et al., EMBO J., 18:512-521, 1999.

Valvekens, et al., Proc. Natl. Acad Sci. USA, 85:5536-5540, 1992.

van Veen et al., Nature, 391:291-295, 1998.

Wadkins and Roepe, International Review of Cytology, 171:121-165, 1997.

Wang, and Guidotti, J. Biol. Chem., 271:9898-9901, 1996.

Weiner et al., J. Biol. Chem., 261:4529-4534, 1986.

Zimmerman, Biochem. J., 285:345-365, 1992.

What is claimed is:

1. A method for increasing the sensitivity of a target cell to an antiinfective comprising contacting the target cell with suramin.

2. The method of claim 1, wherein the target cell is a bacterial cell.

3. The method of claim 1, wherein the target cell is a yeast cell.

4. The method of claim 1, wherein the target cell is a plant cell.

5. The method of claim 1, wherein the antiinfective is an antibiotic.

6. The method of claim 1, wherein the antiinfective is an antifungal.

7. The method of claim 1, wherein the antiinfective is a pesticide.

8. The method of claim 7, wherein the pesticide is an insecticide.

9. The method of claim 7, wherein the pesticide is a fungicide.

10. The method of claim 7, wherein the pesticide is a herbicide.

11. The method of claim 7, wherein the pesticide is a nematicide.

12. The method of claim 7, wherein the pesticide is a miticide.

13. The method of claim 7, wherein the pesticide is a algaecide.

14. The method of claim 1, further defined as comprising contemporaneously administering said antiinfective and said suramin.

15. The method of claim 1, further defined as comprising simultaneously administering said antiinfective and said suramin.

16. The method of claim 1, wherein contacting comprises administering a pharmaceutical composition comprising said suramin to an organism comprising said target cell.

17. The method of claim 16, wherein the pharmaceutical composition comprises said antiinfective.

18. The method of claim 14, further defined as contemporaneously administering said antiinfective and said suramin to an organism comprising said target cell.

19. The method of claim 18, wherein the organism is an animal.

20. The method of claim 19, wherein the organism is a plant.

21. The method of claim 18, wherein the organism is a mammal.

22. The method of claim 19, wherein the organism is a human.

23. The method of claim 1 further defined as a method for decreasing drug resistance of a target cell, wherein the target cell exhibits multidrug resistance.

24. The method of claim 23, wherein the target cell is resistant to an antibiotic.

25. The method of claim 23, wherein the target cell is resistant to an antifungal.

26. The method of claim 23, wherein contacting comprises administering the suramin in a pharmaceutical composition.

27. A method for increasing the sensitivity of a plant cell to a herbicide comprising contacting the plant cell with suramin.

28. The method of claim 27, further defined as comprising contemporaneously administering said herbicide and said suramin.

29. The method of claim 27, further defined as comprising simultaneously administering said herbicide and said suramin.

30. The method of claim 27, wherein contacting comprises contacting a plant comprising the plant cell with said suramin.

31. The method of claim 27, wherein the plant cell is further defined as resistant to at least a first herbicide.

32. A pharmaceutical composition comprising suramin and an antibiotic in a pharmaceutically acceptable carrier or diluent.

33. A pharmaceutical composition comprising suramin and an antifungal in a pharmaceutically acceptable carrier or diluent.

34. The composition of claim 33, wherein the antifungal is a fungicide.

35. A composition comprising suramin and a pesticide.

36. The composition of claim 35, wherein the pesticide is an insecticide.

37. The method of claim 35, wherein the pesticide is a fungicide.

38. The method of claim 35, wherein the pesticide is a herbicide.

39. The method of claim 35, wherein the pesticide is a nematicide.

40. The method of claim 35, wherein the pesticide is a miticide.

41. The method of claim 35, wherein the pesticide is an algaecide.
